(19) United States
(12) Patent Application Publication
(10) Pub. No.: US 2024/0059025 A1
(43) Pub. Date: Feb. 22, 2024

(54) DEVICES, SYSTEMS, PROCESSES, AND METHODS RELATING TO TANKLESS PRODUCTION OF THREE-DIMENSIONAL TARGET OBJECTS

(71) Applicant: Kinetic 3D LLC, Kirkland, WA (US)

(72) Inventor: Scott Robert Leatham, Duvall, WA (US)

(73) Assignee: Kinetic 3D LLC, Kirkland, WA (US)

(21) Appl. No.: 18/119,084

(22) Filed: Mar. 8, 2023

Related U.S. Application Data
(60) Provisional application No. 63/317,900, filed on Mar. 8, 2022.

(51) Int. Cl. B29C 64/40; B29C 64/106; B29C 64/245; B29C 64/255; B29C 64/336; B33Y 80/00; B33Y 30/00

(52) U.S. Cl. CPC B29C 64/40; B29C 64/106; B29C 64/245; B29C 64/255; B29C 64/336; B33Y 80/00; B33Y 30/00

(57) ABSTRACT

Devices, systems, processes, etc., for creating/printing 3D target objects without the need for pre-existing tanks that hold resins from which the target object is created. Such target objects can be created, for example, through the use of stereolithography (SLA) or digital light projection in combination with selected light sources and photosensitive polymers and resins. In certain embodiments, a dynamic shell that holds the resin is created simultaneously with the target object.

### BACKGROUND

3D printers, which digitally print 3D target objects, are commonly available. Examples of such 3D printers include Stereolithography (SLA) and Digital Light Projection (DLP) printers, collectively referred herein as SLA 3D printers. Such SLA 3D printers produce 3D target objects by using a laser or other energy source to cure photosensitive liquid resins. SLA printers can typically make high resolution 3D target objects with superior surface quality compared to conventional Formative Deposition Model (FDM) 3D printers, which typically make 3D target objects by extruding solid polymer filament. Other 3D printers/3D printing methods include SLS printing, which uses a laser to fuse suitable powders held in a powder bin, similar to the liquid polymer printing vat used in SLA printers, multi-jet fusion (MJF, such as a HP MJF), Selective Laser Melting (SLM) and Direct Metal Laser Sintering (DMLS). These and other exemplary 3D printing systems are generally described at https://www.bubs.com/knowledge-base/material-processes-explained/. (Various references are set forth herein that discuss certain systems, apparatus, methods and other information; all such references are incorporated herein by reference in their entirety and for all their teachings and disclosures, regardless of where the references may appear in this application. Citation to a reference herein is not an admission that such reference constitutes prior art to the current application.)

3D printing systems typically have preexisting printing tanks, trays or vats. (Collectively herein, “preexisting printing vat”. Also, “printing vat” in this context indicates a vat, tray, tank, etc., in which the 3D printing takes place, as opposed, for example, to a preexisting reservoir, vat or tank (herein after, “supply reservoir”. Further, “printing arena” indicates an area where 3D printing takes place, and a “vat-less printing arena” indicates a printing arena that does not have any preexisting printing vat.) 3D printing systems typically have the supply reservoir operably connected to the preexisting printing vat in the 3D printer, which supply reservoir holds and provides resin or other 3D-printing material to the preexisting printing vat in which to build the target object. Such 3D printers suffer from one or more of lack of precision, waste of materials, waste of components, limits on the type of materials that can be used, excessive and expensive post-processing, or other disadvantages.

Thus, there has gone unmet a need for 3D printing devices, systems, methods, etc., that increase precision, speed, reduce waste of materials and/or possibly expand the type of materials that can be used, for example when compared to those 3D printers requiring preexisting printing vats in which to build the target object such as SLA 3D printers. The present systems and methods, etc., provide solutions to one or more of these needs, and/or one or more other advantages.

### SUMMARY

The current systems, devices, methods, etc., significantly reduce difficulties with 3D printing in several ways, including by creating a “dynamic shell” vat in the printing arena, which dynamic shell can be form-fitting to match the shape of the target object, including for example both the target object and the dynamic shell having matching bi-directional curves. This dynamic shell reduces the amount of liquid polymer/ink that is needed and/or provides bespoke vat shapes that support or otherwise allow or enhance even the building of 3D shapes that previously could not be created. Such systems, devices, methods, etc., also expand the utility of SLA and other previous vat-based printers/printing systems and provide new ways to make 3D target objects, which can in turn allow for more different build materials to be used across a broad range of existing target object designs and can use new photosensitive resin curing systems. Additionally, the systems, devices, methods, etc., provide for greater scalability.

The present systems, devices and methods, etc., provide three-dimensional (3D) printers, systems, combinations, etc., lacking a preexisting printing vat and containing a dynamic shell printed by the 3D printer and can have an interior space within the dynamic shell, such interior space holding a target object printed by the 3D printer. The dynamic shell further can comprise dynamically created, non-vertical guywires holding the target object to the dynamic shell, which can be about 200 μm or less in diameter.

The dynamic shell and the target object can be made of a same 3D printing material or different 3D printing materials; the dynamic shell and target object can also each be made of a single printing material and/or multiple printing materials. The 3D printing material can be a liquid photosensitive resin that cures into a solid when struck with a suitable activation light. The dynamic shell can further hold at least one dynamically created auxiliary structure, and the auxiliary structure can be a diffuser that diffuses liquid printing material being delivered into the interior space within the dynamic shell. The auxiliary structure can comprise plumbing that conducts printing material from a first location within the dynamic shell to a second location within the dynamic shell. The plumbing can be located entirely within the dynamic shell, and the plumbing can comprise at least one of a pipe, an elbow, a splitter, a joint, a reservoir, an expansion chamber, a restrictor, a flow-through gap, a ballast chamber, a concentric geometry, a diffusion plate, or an on-demand valve.

The 3D printer can be in process of building the target object. The 3D printer can be in process of printing the target object and simultaneously printing the dynamic shell.

The shape of the dynamic shell can substantially match the exterior shape of the target object, and both the target object and the dynamic shell can have matching bi-directional curves. The 3D printer can be a “top-down” stereolithography (SLA) or digital light projection (DLP) printer capable of 3D printing the target object from a photosensitive liquid resin, or can be a “bottom-up” stereolithography (SLA) or digital light projection (DLP) printer capable of three-dimensional (3D) printing a target object from a photosensitive liquid resin.

The dynamic shell can comprise partial perforations for easy splitting open of the dynamic shell. The 3D printer can comprise a build plate holding the dynamic shell and target object. The build plate can be controllably movable in a z-axis relative to the dynamic shell and target object in order to print the dynamic shell and target object in a layer-by-layer manner. The 3D printer can be a continuous downward flood printer or the 3D printer can be an upward flood printer. The curing energy can be for example provided by two triangulated lasers, a single laser, or a rectangular area projector.

The dynamic shell can contain multiple target objects, which multiple target objects can have different shapes. The multiple target objects can be each held to an interior surface of the dynamic shell by guywires and can be disposed in a stack one above another without touching. The dynamic shell can be comprised of a dynamic shell wall, which dynamic shell wall can have a substantially even wall thickness from top to bottom of the dynamic shell wall. An outer surface of the dynamic shell wall can be knurled, and can comprise at least one of a diagonal pattern, diamond pattern, squares pattern, whiskers, screw threads or triangles pattern. The dynamic shell wall can have a pyramidal thickness that increases from bottom to top or from top to bottom. An inner surface of the dynamic shell wall can be substantially vertical and an outer surface of the dynamic shell wall can be slanted relative to an inner surface. The dynamic shell wall can have a substantially continuous thickness from top to bottom and wherein an outer surface of the dynamic shell wall and an inner surface of the dynamic shell wall can be equally slanted relative to vertical. The dynamic shell can comprise grooves that selectively distribute printing material to desired target areas within the dynamic shell.

The 3D printer can contain a plurality of the dynamic shells, each dynamic shell containing a separate target object, and can contain a plurality of inlet ports supplying printing material to the dynamic shell, each inlet port supplying a different printing material. The different printing materials can be different photosensitive resins. The 3D printer can contain at least one target object comprising each of the different printing materials. The 3D printer can contain at least a first target object made of a first printing material and a second target object made of a second printing material, and there can be a gap between a wall of the dynamic shell and the target object of sufficient size to ensure the target object can be not affected by light scattering that may occur between the wall of the dynamic shell and the target object.

Also included herein are methods comprising making or using the printers, systems, dynamic shell, target objects, etc., herein.

In some aspects, the present systems, devices and methods, etc., provide three-dimensional (3D) printing systems lacking a preexisting printing vat and containing a dynamic shell printed by the 3D printer and can have an interior space within the dynamic shell, such interior space holding a target object printed by the 3D printer, the 3D printing system further comprising a storage reservoir holding printing material and operably connected to the dynamic shell and target object to provide printing material to the dynamic shell and target object, an energy source that selectively cures the printing material to create the dynamic shell and target object, a build platform moveable in a z-axis to vertically move the dynamic shell and target object when the dynamic shell and target object can be being built, and a computer for controlling the 3D printing system.

In further aspects, the present systems, devices and methods, etc., herein comprise dynamic shells printed by a 3D printer, system, etc., herein, the dynamic shell can have an interior space within the dynamic shell, such interior space containing a target object printed by the 3D printer at substantially the same time as the dynamic shell. The dynamic shell can be located within three-dimensional (3D) printers, systems, combinations, etc., herein.

In some aspects, the present systems, devices and methods, etc., herein comprise methods of three-dimensional (3D) printing a target object comprising:
a) providing three-dimensional (3D) printers;
b) 3D printing a dynamic shell can have an interior space within the dynamic shell; and,
c) 3D printing a target object within the interior space of the dynamic shell;

In some methods, the 3D printer does not have a preexisting printing vat, and the dynamic shell and the target object can be printed substantially simultaneously.

The methods further can comprise: d) printing guywires connecting the dynamic shell and the target object, or 3D printing at least one auxiliary structure within the interior space of the dynamic shell.

In some further aspects, the present systems, devices and methods, etc., herein comprise methods of three-dimensional (3D) printing a target object comprising:
a) providing a three-dimensional (3D) printing system that does not have a preexisting printing vat, a storage reservoir holding printing material and operably connected to supply the printing material to a printing zone on a z-axis moveable build platform, an energy source that selectively cures the printing material in the printing zone, and a computer for controlling the 3D printing system;
b) executing 3D printing instructions to cause the 3D printing system to 3D print a dynamic shell in the printing zone, the dynamic shell can have an interior space;
c) executing 3D printing instructions to cause the 3D printing system to 3D print a target object within the interior space of the dynamic shell; and,
d) executing 3D printing instructions to cause the 3D printing system to 3D print guywires holding the target object to the dynamic shell.

The methods of three-dimensional (3D) printing can also comprise:
a) providing a three-dimensional (3D) printing system that does not have a preexisting printing vat, a storage reservoir holding printing material and operably connected to supply the printing material to a printing zone on a z-axis moveable build platform, an energy source that selectively cures the printing material in the printing zone, and a computer for controlling the 3D printing system;
b) generating in a CAD program 3D a design for a target object and a dynamic shell within which to build the target object and guywires holding the target object to an interior surface of the dynamic shell;
c) generating 3D printing instructions for layer-by-layer printing the target object, the dynamic shell and the guywires;
d) executing the 3D printing instructions to cause the 3D printing system to layer-by-layer build at substantially the same time all of the dynamic shell, the target object and the guywires in the printing zone.

The methods further can comprise generating 3D printing instructions for layer-by-layer 3D printing at least one auxiliary structure in addition to the dynamic shell, target object and guywires, and executing the 3D printing instructions to layer-by-layer 3D print the at least one auxiliary structure.

The methods further can comprise post-processing the target object after the target object can be printed; removing the dynamic shell and target object from the 3D printer; removing the target object from the dynamic shell; and, removing the guywires holding the target object within the dynamic shell.

In some further aspects, the present systems, devices and methods, etc., provide three-dimensional (3D) printers and printing systems that can have a build plate can have a supply port therein, the supply port operably connected to 3D-printing material supply reservoir and to a 3D-printing arena within the 3D printer. The supply port can contain 3D-printing material, and the 3D-printing material within the supply port can be moving from the 3D-printing material supply reservoir through the supply port to the 3D-printing arena. The supply port can comprise a receiving portion to receive the 3D-printing material from the 3D-printing material supply reservoir and a feed portion to feed the 3D-printing material to the printing arena of a 3D printer. The supply port can comprise a 3D-printing material meter that measures the quantity of 3D-printing material delivered through the supply port to the printing arena.

The build plate can comprise a plurality of supply ports. Each of the plurality of supply ports can be operably connected to an equal number of different 3D-printing material supply reservoirs, and each of the equal number of different 3D-printing material supply reservoirs can contain a different 3D-printing material. The build plate and the supply port therein can be disposed above the 3D-printing arena, and the build plate and the supply port therein can be disposed below the 3D-printing arena. The 3D printing system lacks a preexisting printing vat and can be configured to print a dynamic shell simultaneously with printing a target object.

The supply port can be a substantially linear hole in the build plate, and the supply port can be substantially non-linear within the build plate and the supply port can comprise both an inlet port operably connected to the 3D-printing material supply reservoir and an outlet port operably connected to the 3D-printing material printing arena.

In still some further aspects, the present systems, devices and methods, etc., provide build plates for three-dimensional (3D) printing systems wherein the build plate can have a supply port that can be operably connectable to both a 3D-printing material supply reservoir and to a printing arena of a 3D printer, wherein the supply port can comprise a receiving portion to receive the 3D-printing material from the 3D-printing material supply reservoir and a feed portion to feed the 3D-printing material to the printing arena of a 3D printer.

The supply port can contain 3D-printing material. The 3D-printing material within the supply port can be moving from the 3D-printing material supply reservoir through the supply port to the 3D-printing arena. The supply port can comprise a 3D-printing material meter that measures the quantity of 3D-printing material delivered through the supply port to the printing arena, and the build plate can comprise a plurality of supply ports. The plurality of supply ports can be operably connectable to an equal number of different 3D-printing material supply reservoirs. The build plate and the supply port therein can be disposed above, within or below a 3D-printing arena located within a 3D-printing arena within a 3D printing system. The build plate can be configured for a 3D printing system that lacks a preexisting printing vat and can be configured to print a dynamic shell simultaneously with printing a target object.

The supply port can be a substantially linear hole in the build plate. The supply port can be a substantially non-linear within the build plate and the supply port can comprise both an inlet port operably connected to the 3D-printing material supply reservoir and an outlet port operably connected to the 3D-printing material printing arena.

In still some further aspects, the present systems, devices and methods, etc., provide three-dimensional (3D) printing systems comprising a 3D printer can have a build plate can have a catch tray sized and disposed to catch overflow 3D-printing material overflowing from an upper surface of the build plate.

The build plate can have a build plate edge and the catch tray can have an abutment surface to abut the build plate edge, the catch tray abutting the build plate edge such that the catch tray can be located to catch overflow 3D-printing material overflowing from the upper surface of the build plate. The build plate edge and the abutment surface form an impermeable seal between them. The impermeable seal can be disposed such that all overflow 3D-printing material can be caught in the catch tray. The build plate and the catch tray can be unitary. The 3D-printing material can be a 3D-printing resin, and the build plate can be a build plate comprising a supply port according to any one of embodiments herein. The catch tray can be operably connected to deliver overflow 3D-printing material in the catch tray to a 3D-printing material supply reservoir, and can fully or partially encircle the build plate.

The 3D printing system can lack a preexisting printing vat and can be configured to print a dynamic shell simultaneously with printing a target object. The 3D printing system can have a wiper for removing excess 3D-printing material from a printing arena, wherein the wiper can be limited to pass over less than a width of a build plate of the 3D printer. The 3D printing system lacks a preexisting printing vat and can contain a dynamic shell on the build plate, the dynamic shell printed by the 3D printer and can have an interior space within the dynamic shell.

The interior space within the dynamic shell can contain a target object. The 3D printing system can comprise software that limits the wiper to pass over less than a width of a build plate of the 3D printer., and the interior space can hold a target object printed by the 3D printer. The size of a single pass of the wiper can be cooperatively sized to traverse slightly farther than a width of the dynamic shell. The 3D printing system further can comprise a wiper cleaner that cleans the wiper after each pass of the wiper.

The wiper and wiper cleaner can be cooperatively shaped such that the wiper cleaner contacts a wiping edge of the wiper contacts to remove the 3D-printing material from the wiping edge. The wherein the wiper and wiper cleaner can be cooperatively shaped such that the wiper cleaner at least partially encompasses a wiping edge of the wiper contacts to remove the 3D-printing material from the wiping edge. The wiper can be rigid or elastic.

The wiper can extend straight down from a wiper arm holding the wiper or bulldozer shaped or otherwise as desired] for removing excess 3D-printing material after each pass of the wiper over the printing arena, wherein the wiper can be limited to pass over less than a width of a build plate of the 3D printer, and the wiper can be bulldozer shaped.

the systems and methods, etc., include such modifications as well as all permutations and combinations of the subject matter set forth herein and are not limited except as by the appended claims or other claim having adequate support in the discussion and figures herein.

These and other aspects, features and embodiments are set forth within this application, including the following Detailed Description and drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIGS. 1A-1E depict an exemplary 3D printer system as discussed herein including a resin port in the build plate.

FIGS. 2A to 2C depict perspective and side plan views of various exemplary dynamically created auxiliary structures such as struts and guywires.

FIG. 3 depicts a high-level flowchart of an exemplary pathway to conduct a dynamic-shell 3D print using the systems, methods, etc., herein.

FIG. 4 depicts a further, more detailed exemplary pathway/flowchart to dynamic-shell 3D print using the systems, methods, etc., herein.

FIG. 5 depicts a high-level schematic example of a top-down type 3D dynamic shell printer according to the systems, methods, etc., herein.

FIG. 6 provides a further high-level depiction of one example of suitable printing steps according to the systems, methods, etc., herein.

FIG. 7 further depicts the dynamic shell and toy tug boat of FIG. 6 being printed.

FIG. 8 provides further schematic views of a dynamic shell and target object (toy tug boat) being created.

FIGS. 9A and 9B depict schematically certain aspects of the methods discussed herein for a bottom-up 3D, dynamic shell printing system.

FIG. 10 depicts schematically certain aspects of the systems and methods discussed herein for a bottom-up 3D, dynamic shell printing system. Note that the steps in the FIG. proceed from bottom right up to top left.

FIG. 11 depicts both schematically and with discussion an example of the systems and methods discussed herein for a bottom-up 3D, dynamic shell printing system.

FIG. 12A depicts an exemplary embodiment of a form-fit dynamic shell and target object with dynamically created plumbing in conjunction with the dynamic shell printing systems herein.

FIG. 12B depicts the complex-shape, form-fit dynamic shell and target object of FIG. 12A with plumbing and external supports.

FIG. 13A to FIG. 13F depict exemplary embodiments of multi-printer dynamic shell printers suitable for use with the with the dynamic shell printing systems herein.

FIGS. 14A and 14B depict exemplary embodiments of degraded dynamic shell walls due to inadequate resin distribution or other conditions.

FIG. 15 depicts an exemplary embodiment of a dynamic shell 3D SLA/DLP Printer suitable for use with prefabricated build tanks/dynamic shells.

FIG. 16 depicts an exemplary embodiment of a dynamic shell 3D printer as discussed herein.

FIG. 17 depicts an exemplary embodiment of a dynamic shell 3D printer as discussed herein having a hybrid build plate and using multiple build materials, which can be used, for example, with a resin supply from above on a gantry, which may or may not be delivered through the build plate.

FIG. 18 depicts an exemplary embodiment of a dynamic shell 3D printer as discussed herein having a laser level, which can be used as resin level or resin height detector.

FIG. 19 depicts multiple views of exemplary embodiments of complex 3D printed dynamic shells and complex target objects as discussed herein.

FIG. 20 depicts multiple views of exemplary cantilevered supports for 3D printed dynamic shells and target objects herein.

FIGS. 21A-21C depict multiple views of exemplary embodiments of dynamic shell 3D printers as well as 3D printed dynamic shells and target objects as discussed herein.

FIGS. 22A-22C depict multiple views of exemplary embodiments of dynamic shell 3D printers as well as 3D printed dynamic shells and target objects as discussed herein.

FIG. 23 depicts an exemplary embodiment of various elements for a build plate 3 having a resin return system to reuse resin within the dynamic shell 3D printer as discussed herein.

FIG. 24 depicts an exemplary embodiment of a dynamic shell 3D printer as discussed herein having a combined build plate and supply reservoir.

FIG. 25 depicts an exemplary embodiment of a dynamic shell 3D printer as discussed herein having a multi-port build plate, which can be used as desired, for example for building reusable dynamic shells which in turn can be for use on a multiple port general purpose build plate. Should be say this here in abstract.

FIG. 26 depicts a dynamic shell printing system as discussed herein comprising multiple reservoirs. Such multi-reservoir systems can provide resins having different characteristics for different parts/portions of the target or dynamic shell, for example different colors, flow characteristics, different set characteristics, different densities, etc. Such multi-reservoir systems can, if desired, be used with multi-port systems such as those in FIG. 21.

The drawings herein are provided within the text with discussion and also as an appendix to assure legibility.

### DETAILED DESCRIPTION

The present systems devices and methods provide approaches to 3D printing that increase precision, reduce waste and that can expand the types of materials that can be used. The current systems, devices, methods, etc., create a dynamic shell during the printing process, which dynamic shell encompasses the target object while the target object is being built-up during the printing process. The dynamic shell can be form-fitting so that it substantially and/or advantageously (e.g., for mechanical advantage when creating/removing the target object) matches the shape of the target object.

### General Discussion of the Embodiments, Aspects, Etc., Herein

The devices, systems, processes, methods, etc., herein comprise dynamically building components of the 3D printer itself while the target object is being built. For example, a dynamic shell that forms a tank for the target object to be built/being built, as well as support structures and auxiliary structures such as guywires and plumbing can be 3D printed at the same time as the target object they are attached to or otherwise helping build. The guywires can be taut and rigid to reduce, or even essentially eliminate in some embodiments, problematic sagging between the target object and the dynamic shell. In contrast, traditional SLA 3D resin printers and certain other 3D printers, utilize a tank, vat or tray (“vat”) that is an immutable hardware fixture of the host 3D printer apparatus, which vat is generally not adaptable in any way for bespoke printing projects or otherwise as desired.

In some aspects, the current systems, devices, methods, etc., employ a “top down” immersion 3D printing systems and processes wherein the printer system builds an immersion tank, herein typically called a “dynamic shell” or a “DynaTank™”, at the same time that the printer system builds the target object(s). The dynamic shell can be built in open air if desired using as little as a build plate that has resin outlet port(s) 3D-printing material, and, in some embodiments, accurate resin provision systems such as an accurate metering system(s) such as dosing metered pump(s) and a resin level detection system such as an interruption detecting laser or a mechanical wiper. Thus, the systems print both the dynamically-created dynamic shell (DynaTank™) and the target object. During the printing process, the dynamic shell is typically supplied with liquid photosensitive resin by a pump via an outlet port in the build plate; the outlet port connects a resin supply reservoir with the interior, open space being created within the dynamic shell, i.e., the location where the target object is also being created. Thus, the tank typically surrounds the resin outlet port so that when resin dispenses from the outlet port the resin is already located within the dynamic shell, although other locations and/or plumbing can be provided if desired.

The target object is typically built immersed inside the dynamic shell or DynaTank™, and if desired overflow of resin can be provided so that there is resin in place to 3D print next layers of the DynaTank™. Overflow resin can be collected in a catch tray and returned to the main resin storage reservoir.

In some aspects, the systems, devices, methods, etc., herein provide for advantageous support or auxiliary structures such as non-vertical, e.g., horizontal guywires or substantially horizontal guywires, and cantilever supports. “Guywires” indicates dynamically created, non-vertical threads or wires printed from the liquid resin and connecting the target object to support structures other than the base plate, for example the side of the dynamic shell, other parts of the target object, dynamically created plumbing, or even non-printed supports such as pillars provided before the print begins. Furthermore, the systems, devices, methods, etc., herein provide for dynamically created plumbing such as hollow pipes to carry resin from a source outside the dynamic shell to a desired location within the dynamic shell, or from one location within the dynamic shell to another location within the dynamic shell. Such dynamically created plumbing can be advantageous, for example to manage resin usage and flow. The current systems, devices, methods, etc., provide excellent even surprising scalability and the ability to compartmentalize and/or mix different resin media and colors.

Turning to some exemplary dynamic-shell 3D printing processes for the systems, etc., herein, in one embodiment the methods, systems, etc., can be implemented as follows:
a) Design a desired target object in a system such as a Computer Assisted Design (CAD) 3D target object editor. Examples are SolidWorks and AutoCAD Fusion 360.
b) Save the target object in a format suitable for use with a preparation software. Suitable formats include the class of mesh target objects, such as .OBJ or .STL format.
c) Load the target object file into a program such as a slicer or mesh editor to prepare it for a specific dynamic-shell 3D printer, such as Pre-form, Cura, and Simplify3D. A slicer program converts the target object into layers (hence the term “slicer”). The programs can be also used to automatically create geometry for guywires and auxiliary structures that keep the target object connected to the build plate, plumb resin to specific areas, etc. The target object is positioned as desired. Multiple copies of the target object (or different target objects) can be added and positioned and oriented for desired dynamic-shell 3D printing, for example based on user experience or preferences. In many printing systems, specific machine control instructions are then output to the 3D printer.
d) The dynamic-shell 3D printer is manually and/or automatically prepared to print, for example by loading resin into a supply reservoir, installing the build plate and setting the initial parameters such as selecting which target object(s) to print.
e) The dynamic-shell 3D printer loads the machine code, which can be for example G-Code, a machine instruction language typically used by computer numerically controlled (CNC) fabrication equipment such as milling machines and lathes. Subsequently the print/build program is run and the dynamic-shell 3D printing process begins and can be monitored by the dynamic-shell 3D printer's control system, or for example via meta data used as control instructions which are provided with one or more images each containing an image pattern of one slice per image.
f) Once the target object is completed in the dynamic-shell 3D printing process, the target object is removed and then sent through a post-processing stage(s).

Turning to some further discussion of particular aspects, embodiments, etc., of the systems, methods, devices, etc., herein (including the embodiments above), embodiments can comprise a build plate with a port in it whereby resin, stored in a separate supply reservoir, is accurately metered and pumped onto the surface of the build plate, then layers of a dynamic shell and target object are formed by light curing a pattern in a series of one layer thick coatings. The light can be provided by, for example, a directed laser or light selectively reflected off, and directed by, a digital micromirror device (DMD) or other DLP or Micro-Electro-Mechanical System (MEMS) device. The light cures not only the first layer of the target object, but also the first layer of the dynamic shell, which dynamic shell forms a vat encasing the target object during the build. In some embodiments, one or two (or more) layers of either the dynamic shell or the target object can be cured/built prior to the other of the dynamic shell or the target object being cured.

Once the first (or later) layer is cured, the pump sends more resin out of the port and the build plate is lowered away from, or otherwise moved way from, the focal plane and the next layer is formed via pattern projection. Typically, each layer is made of the slices of the target object and slices of the dynamic shell. As resin is pumped out the port, the resin tops-off the resin level, typically spilling some resin over the top of the dynamic shell while leaving enough behind to build the next layer of the dynamic shell's walls. This layering is repeated until the target object is completely formed. At completion, the target object is typically fully immersed inside its custom dynamic shell, and resin spillover is collected in a catch tray and conveyed back to the supply reservoir. To remove unneeded, still-liquid resin, the pump can be reversed to drain the resin from the dynamic shell. The recovered resin can be put through a filter and returned to the supply reservoir for use in the next 3D printing job.

The target object, which is still inside its dynamic shell is removed from the build plate, then extracted from the dynamic shell and if desired sent to the post processing phase. In some embodiments, it is possible to reuse the dynamic shells.

In some aspects, the present systems, devices and methods, etc., provide non-vertical supports, for example horizontal supports, which can be called guywires or guide wires. These can be very thin filaments that are dynamically 3D printed along with the target object and the custom 3D printed dynamic shell. The guywires help support the dynamic shell and/or target object, even assuring that the dynamic shell is self-supporting. The guywires can also keep the target object layers from shifting during the printing and filling process. The guywires can be selected and configured to take advantage of factors such as: 1) Hardened resin is equally buoyant in uncured liquid resin, and 2) connecting the guywire to the inside wall of the dynamic shell adds some minute tension to the guywire if the resin is selected to shrink slightly upon curing, which tension helps securely hold the target object in place. The size of contact points of the guywires to the target objection can be configured to be quite small, as small as 30 um², so post-processing can be greatly simplified because the guywires can be easily removed with very little effort and leave almost no surface deformation.

Dynamic shells can be made any size or shape as needed or desired to print virtually any type of target objects. Dynamic shells can also be created to span multiple 3D printers thus providing a means of incremental scalability to produce large target objects simply by adding printers.

The devices, systems, processes, methods, etc., herein also include dynamically created plumbing, for example to effectively distribute resin evenly or specifically throughout the build volume of the dynamic shell. This can, for example, reduce excessive fluid movement and turbulence. The plumbing is dynamically 3D printed at the same time as the dynamic shell and the target object. Any given guywire or overhang comprising hardened resin may remain in place due buoyancy, at least until more resin or other build medium is pumped into the dynamic shell. This influx of the build medium, which is typically a heavy liquid or fluid can dislodge guywires and deform layers of overhanging geometry patterns or otherwise wreak havoc within the build zone. Therefore, the auxiliary structures herein such as pipes, elbows, splitters, various joints, reservoirs, expansion chambers, restrictors, flow through gaps, ballast chambers, concentric geometry, diffusion plates, and on-demand valves for sealing of plumbing pathways or other control of fluid dynamics of the resin flow. Plumbing may be dynamically formed on the inside, outside, or in between the walls of the 3D printed resin dynamic shell.

Turning to software or other computer-readable instructions to generate the resin dynamic shell, target object, etc., the devices, systems, processes, methods, etc., herein include manually or programmatically generating 1) 3D geometry for the dynamic shell, 2) 3D geometry for auxiliary structures such as auxiliary supports such as guywires or plumbing, and 3) placement of the target 3D target object within the dynamic shell and corresponding auxiliary structures. Such elements can be achieved with “slicer” software, which generates the shell, auxiliary supports, etc., so that the supports make physical contact with isolated, or island or waste, geometry such as with geometry that is an overhang, or peninsula, that is partially attached to an already supported layer. The guywires can be quite thin, for example 20 um, 20 um, 2 um or less diameter, and can also be of any desired cross-sectional shape, for example circle, oval, rectangle, square, triangle, etc. The guywires can be straight or selectively non-straight such as curved or angled between one end of the guywire to the other end (or with multiple different cross-sections and/or axillary shapes). The guywires can be taut and/or rigid such that there is no significant sagging between the target object and the dynamic shell. In some embodiments, such tautness and/or rigidity can be imparted or enhanced by use of a resin that shrinks slightly upon curing thereby imparting tension to the guywire. The guywires can triangulated and extend from the 3D target object to the inside wall of the dynamic shell. The software used to create the guywires can also create the dynamic shell such that guywires contact desired positions on the dynamic shell, typically on the inside wall of the dynamic shell. In the case of tall or thin target objects, the slicer software can produce guywires for the purpose of keeping the 3D target object from moving during the resin filling process. For example, if the target object is a tall narrow wing shape, such as a tail for a model airplane, to printed vertically, then as the resin is pumped into the dynamic shell, then if the wing is not supported by guywires then fluid flow dynamics of incoming resin could cause the wing to reposition or deform due to its shape. To avoid this, guywires can be generated at desired appropriate height intervals to inhibit the 3D target object from moving during 3D printing. The more guywires created, the faster the resin can flow, and the faster the 3D target object can be printed. The slicer software can also be responsible for producing geometry for any plumbing and other desired auxiliary structures to properly distribute liquid resin or for other purposes.

The devices, systems, processes, methods, etc., herein include upward flood dispensing of the photosensitive resin in upward flow dynamic shell 3D printers, and related methods. The liquid resin is injected into the build zone through one or more outlet ports, defusing manifolds, etc., which can be built into the build platform or provided adjacent such platforms. The liquid resin is typically carefully metered and pumped from a supply reservoir onto the build platform until the build zone of the build platform is completely covered, thereby providing a layer of liquid resin for the first layer of the 3D target object and its dynamic shell.

Once the layer is formed, the pump stops for the next step of forming the layer thickness. In certain embodiments, subsequent layers are only flooded enough to cover the edges of the dynamic shell. Excess resin eventually drips into a catch gutter surrounding the build platform and flows back into the resin supply reservoir by means of a pipe and filter system. The image/geometry of the target object's first layer is then projected onto the liquid resin in the build zone of the build platform to form the first layer of the 3D target object and the first layer of the 3D printed resin dynamic shell. Accurate layer thickness (10 um to 300 um typical) can achieved by use of traditional 3D printing methods such as a sweeper for finer resolution, and by delaying curing to allow the resin to distribute evenly. This can set the layer thickness based on the surface tension of the host resin, for example from 100 um to 300 um. Subsequently, the build platform is lowered or otherwise moved by the desired layer thickness, more fluid is pumped inside the dynamic shell, thus “topping off” the dynamic shell with a small amount of resin overflowing over the side of the dynamic shell and the last layer of the 3D printed target object, any spillage of the top edge of the dynamic shell is caught in the gutter and recycled. The process repeats until the 3D target object and its dynamic shell are fully formed.

The devices, systems, processes, methods, etc., herein include continuous flood systems. For example, the devices, systems, processes, methods, etc., herein include continuous flood of resin into the build zone and the dynamic shell. This eliminates the need to stop the pump between layer curing. Controlling the pump speed can control the flow rate of the resin, which flow rate can be dynamically adjusted to keep pace appropriate to the rate at which a given layer is formed. In cases where guywires or other support structures and first layers of overhanging geometry are formed, the pump can be stopped completely if desire, whereas if a new layer is supported by the previous layer then the rate of fill can be adjusted to keep up with rate at which the light source forms the layer. This can provide for exceptionally fast 3D target object formation.

In some embodiments, the continuous flow approach can be achieved by utilization of two triangulated lasers, whereby each laser, alone, has insufficient intensity to harden the photo-reactive resin, so curing takes place only when both lasers are focused on the same location to exceed the resin's activation threshold. For example, if the desired thickness of a layer is 90 um, then the lasers will start drawing the layer pattern at um above the previous layer. As the fluid resin floods the cavity, the laser(s) continually draws the pattern focused at the 30 um level above the previous layer. The region of liquid resin between the 30 um level and the final 90 um level is also hardened as the light passes through, because the spot size of the triangulated laser beams is 30 um. The laser pattern needs only three passes to achieve. focusing on the next sublayer upwards by the time the resin has reached 90 um. The fill rate can adjusted based on the volume of the dynamically created dynamic shell and the volume of the layer thickness with the laser power factored in. Typically, resins containing pigment should be photoreactive to 100 um depth. Highly opaque resins should be transparent to the wavelength of the activation light being used to achieve high rates of 3D target object formation. In some embodiments, where such transparency is limited, the layers can be made thinner, although the overall operation typically takes longer to form the final 3D target object.

The devices, systems, processes, methods, etc., herein can also be used to create multiple, different or identical stacked target objects. The multiple target objects can have different shapes and can be side-by-side or stacked one upon another. The multiple target objects can be held to an interior surface of the dynamic shell by guywires and can be disposed in a stack one upon another without touching each other. Such stacked objects can be made without interference with target objects lower in the stack. For example, in traditional SLA 3D printing it is difficult to create a vertical stack of target objects because the support structures are vertical. The upper target object must be attached via support to the target object below it, or a custom frame must be created such that target objects and their support structures do not geometrically interfere. The current devices, systems, processes, methods, etc., can be used to created stacked target objects by way of horizontal guywires. Therefore, stacked target objects do not interfere with each other. Also, target objects built horizontally next to each other can share guywires so that sufficient tension is formed to ensure the target object does not move during the flooding process.

The devices, systems, processes, methods, etc., herein provide superior scalability in part because of the dynamic shell, which permits dynamically creating both dynamic shell and 3D target objects spanning multiple build plates. The systems herein can comprise two or more 3D printers mechanically or otherwise operably coupled or connected to functionally form a single large 3D printer. Such operable connections can include specific software control directed to the grouped printer devices, as well as device networking. In some embodiments, a robot arm may be provided to act as a wiper/sweeper if such is desired. Creation of large target objects in a quick manner in traditional machines often utilizes 300 um to 500 um layer thickness. However, the systems herein can achieve such large objects in the same amount of time, or even less time, with a finer layer thickness of about 100 um to 30 um because of the scalability and dynamic shell, etc., herein. Coupled systems can be arranged, for example, in a simple 1D line, a 2D evenly spaced matrix, or offset to form an organic shaped path such as a circle or kidney shape or other shape-specific path as desired.

### General Discussion of the Drawings

The FIGS. and discussion below depict various exemplary embodiments of the systems, devices, etc., herein.

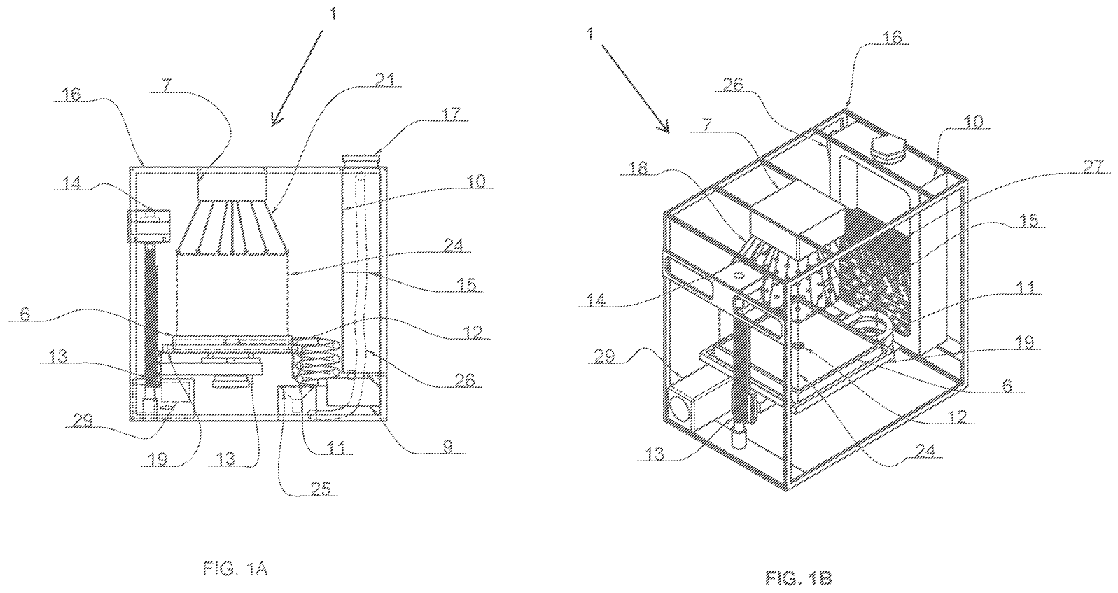

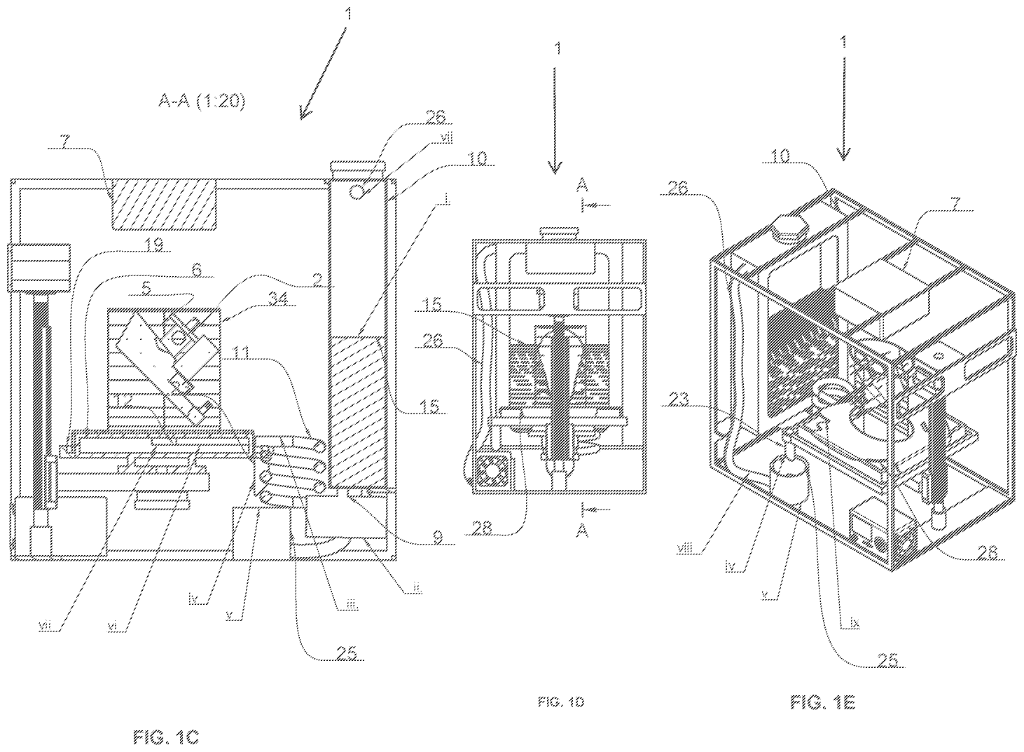

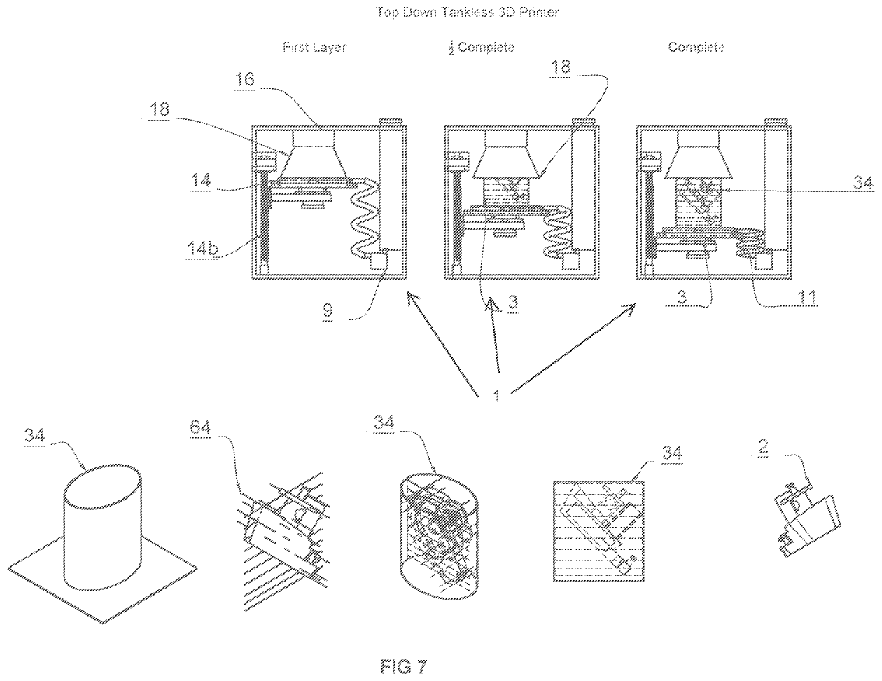

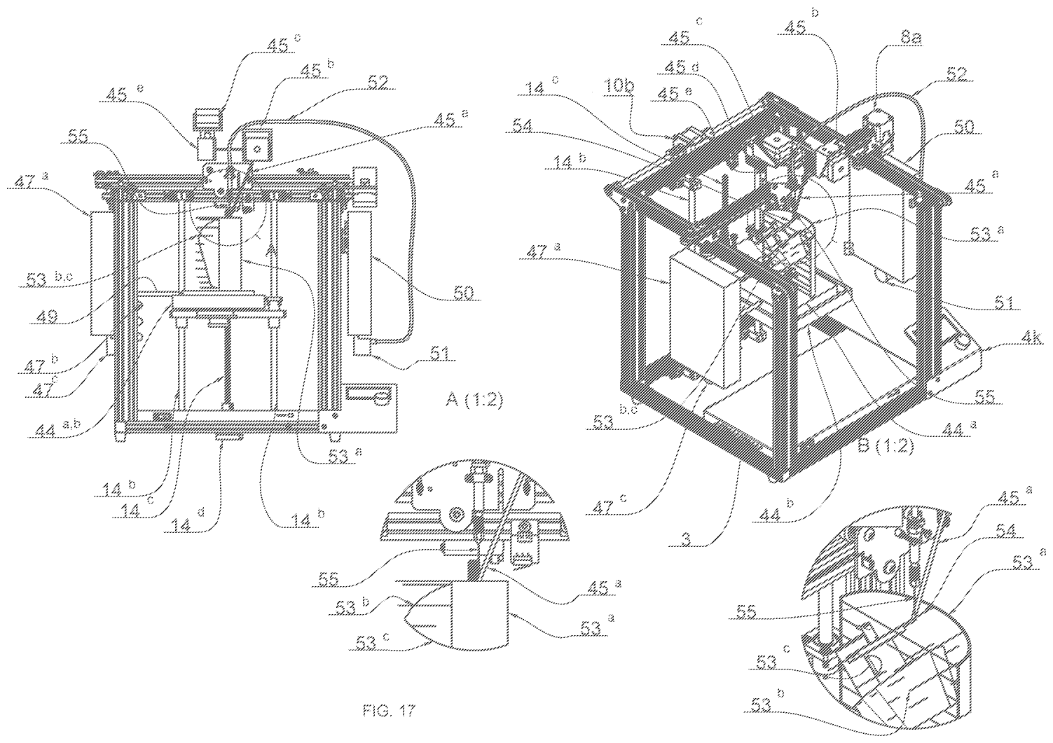

FIGS. 1A-1E and 5 depict exemplary tankless 3D printer systems 1 as discussed herein with FIGS. 1A-1E including a resin port in the build plate. These FIGS. provide high-level depictions of 3D dynamic shell printers herein in a simplified format. In the FIGS. below, the 3D printer is a top-down type of SLA printer, so the build plate moves downward during printing. In the FIGS. the dynamic shell 6 (FIG. 1C to FIG. 1E) or 17 (FIG. 5) and target object 18 therein have already been substantially printed/built.

One example for using the embodiments shown in FIGS. 1A-1E can be as follows:

First layer of resin. This layer forms a seal with the base/build plate 3. The thickness and area-coverage of the layer can be established as desired. As the resin is delivered, the resin coats the build plate 3. In some embodiments, the resin can be held in a shallow recess in the build plate such as a 100 um deep depression, depending on resin characteristics or other factors.

One example of a resin flow and build process:
i. Resin stored in reservoir 10 flows to the build plate 3, for example by pump pressure and/or gravity to a reservoir outlet at the bottom of the reservoir 10.
ii. A metered dosing pump 9 conveys a measured, desired amount of resin into extendable tube 11.
iii. Resin flows towards the resin inlet port 12 in build plate 3
iv. Dynamic shell 34 and target object 2 are built
v. For the resin supply for the dynamic shell and target object, resin is conveyed into the build arena starting at the top of the build plate 6 via build plate inlet port 12; resin flows through the inlet port 12 in build plate 6 into the build arena.
vi. Ultimately, unused or excess resin spills over into the catch tray/gutter 19. In turn, such spill-over resin pours into the return drain pipe 23
vii. The excess resin in the return drain pipe 23 then drips or otherwise flows into resin recovery system 25, which as shown comprises a catch basin, filter and return pump.

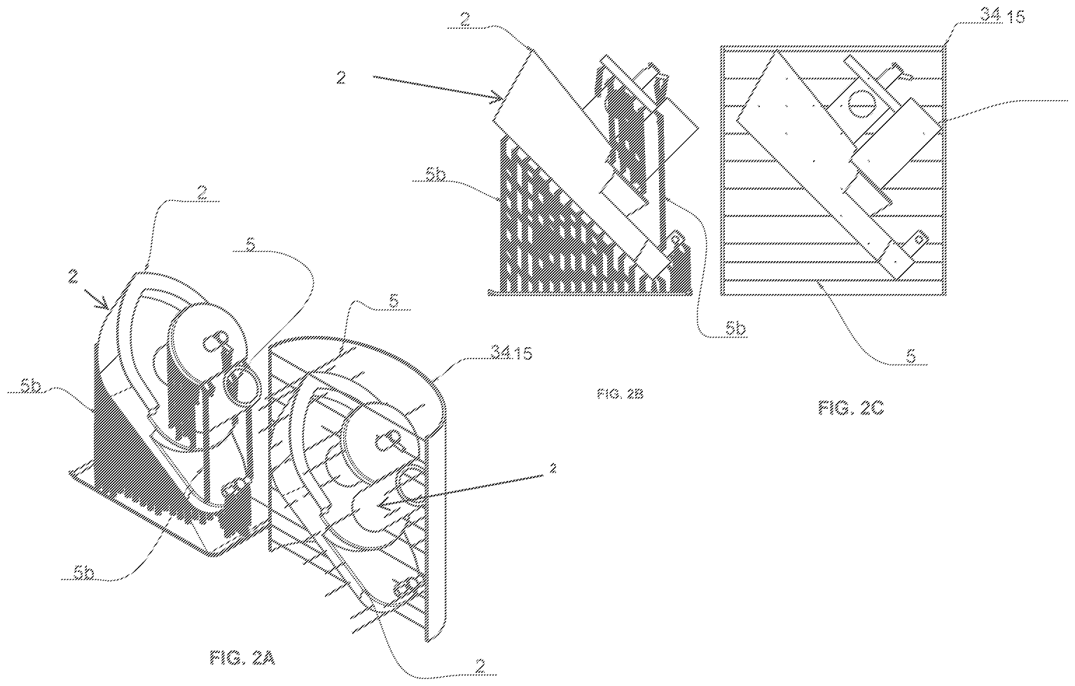

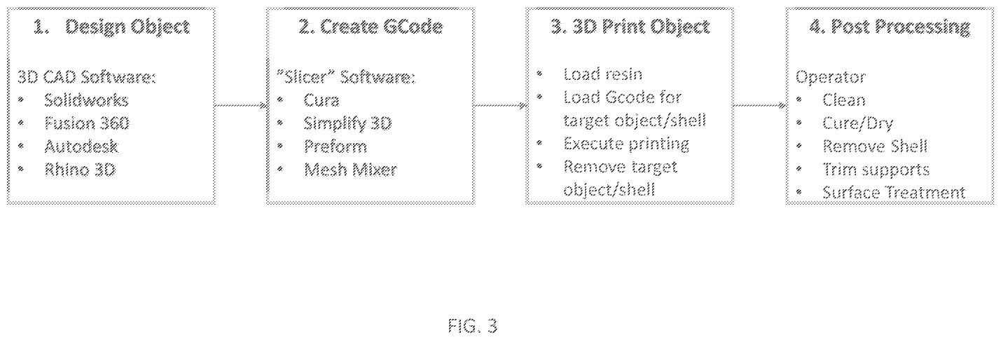

FIG. 2A to 2C depict some exemplary auxiliary structures such as guywires 5, that can be utilized in or with the dynamic shell printing system herein, compared to exemplary support structures used in traditional 3D printing systems.

3 provides a high-level flowchart of an exemplary pathway to conduct a dynamic-shell 3D print using the systems, methods, etc., herein:

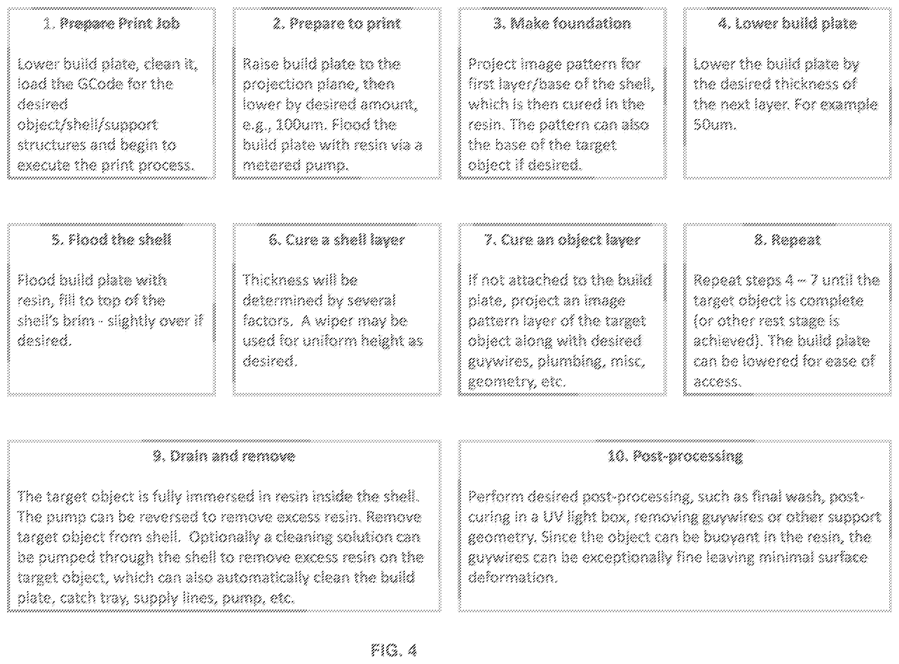

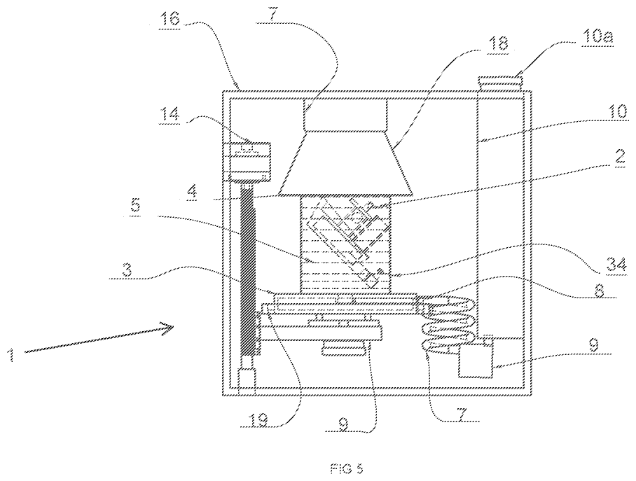

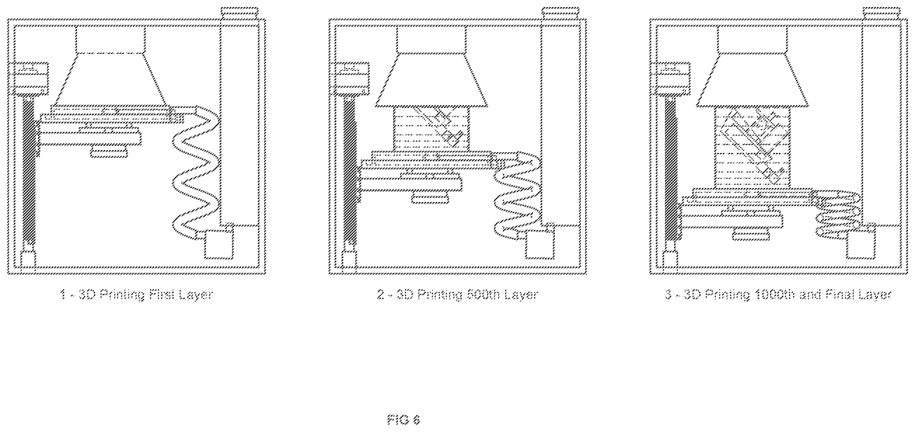

FIG. 4 provides a further, more detailed exemplary pathway/flowchart to dynamic-shell 3D print using the systems, methods, etc., herein:

FIG. 5 depicts a high-level schematic example of a top-down type 3D dynamic shell printer according to the systems, methods, etc., herein. In FIG. 5:
1 tankless 3D printer system
2 target object (toy tug boat)
3 Build Plate
3c build plate support (mounted to Z-axis vertical control, bracket and lead screw)
4 Focal plane, for example of projected image (DLP) or laser (SLA)
5 Guywires—thin support structures, in this embodiment oriented horizontally
6 inlet port 6 (inlet to build arena, can also be considered as an outlet port from resin supply)
7 Light source (e.g., laser/galvo, DLP projector, LCD screen)
8 resin inlet port and delivery tube
9 Metering resin pump
10 Reservoir
10a reservoir filler cap
11 Extendable resin delivery hose—Coiled hose between supply reservoir and resin output port in build plate 3. This hose can be configured to move the build plate 3.
14 Z-axis drive motor
16 Frame of printer
18 Light projection cone
19 Resin spill-over catch tray and return port
34 dynamically 3D printed resin tank (dynamic shell), filled with resin via inlet port from reservoir by the metering pump

FIG. 6 provides a high-level depiction of one example of the printing steps discussed above of a dynamic shell printing process, etc., in a simplified format. In the FIG., the 3D printer is a top-down type of SLA printer, so the build plate moves downward during printing, and the FIG. shows only the printing steps, not prep or post-processing portions.

FIG. 7 provides a high-level depiction of the dynamic shell and toy tug boat in FIG. 6 being printed, without showing the printing devices and systems. In FIG. 7 below:
2 target object removed from dynamic shell, guywires trimmed off and ready for surface treatment as desired for resin based prints, such as painting, sanding, hardening.
34 Dynamically created resin immersion tank, with base seal
64 Resin inside of dynamically created immersion tank, this is also the projection plane

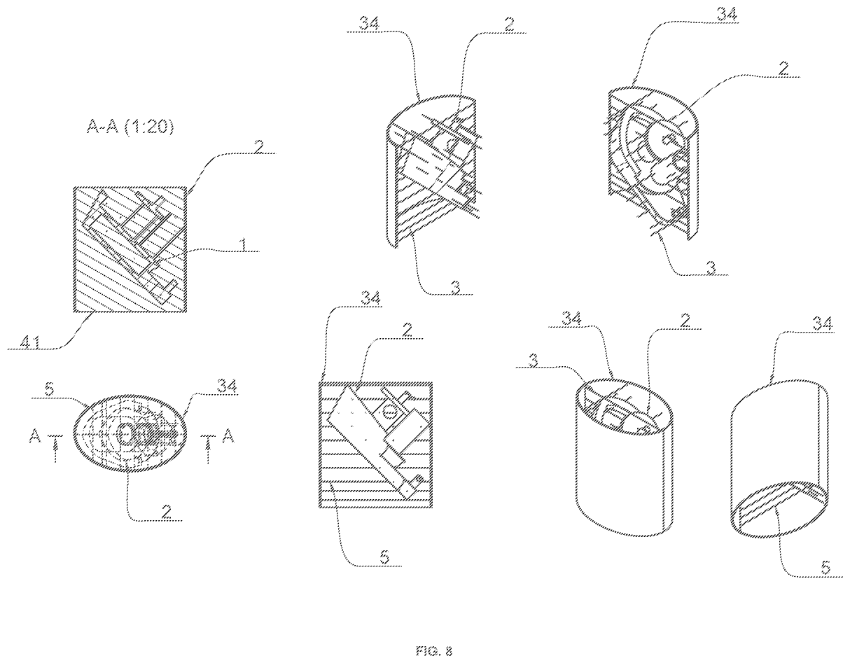

FIG. 8 provides further views of a dynamic shell 34 and target object 2 (toy tug boat) being created. In FIG. 8:
2 target object (cutaway view) in dynamic shell, suspended by guywires and buoyancy
34 3D Dynamically created immersion tank (dynamic shell)
5 guywires dynamically 3D printed
41 Resin

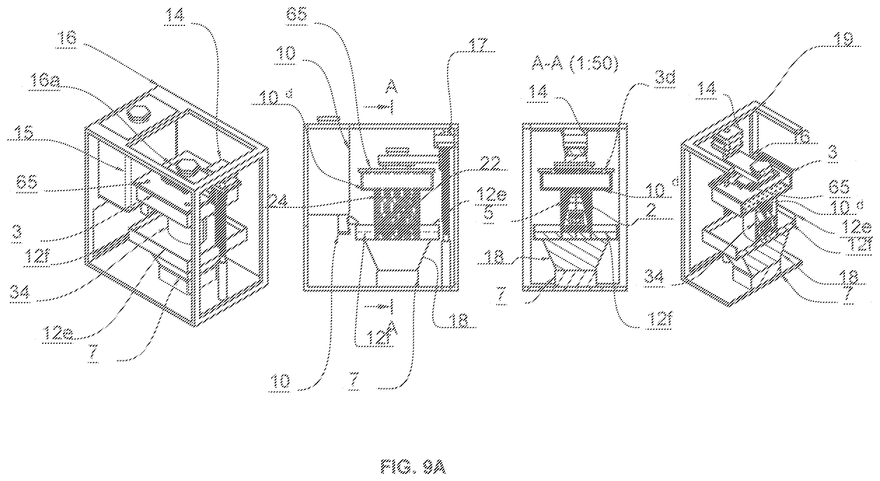

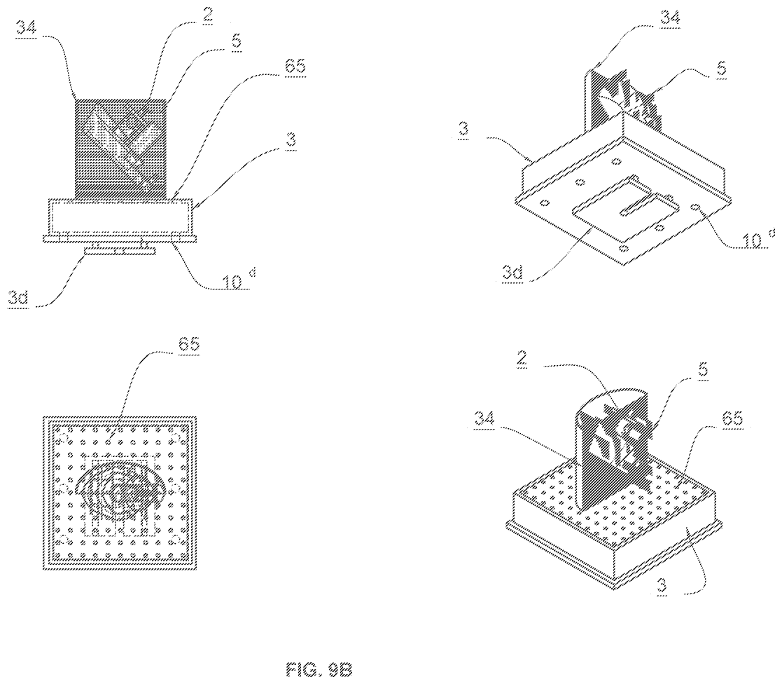

FIGS. 9A and 9B depict schematically certain aspects of the methods, devices and systems discussed in the preceding paragraphs for a bottom-up 3D, dynamic shell printing system. In FIGS. 9A and 9B:
2 target object (toy tug boat)
3 build plate
3d build plate attachment point
5 Guywires (secures target object to dynamic shell)
7 Light source
10 resin supply reservoir
10d Air output holes
12e Resin tank/tray
12f Resin level in vat (tank/tray)
14 Z-Axis positioning assembly and motor
16 Frame
16a Build plate support bar for Z-axis
34 Dynamic Shell
65 Air inlet holes

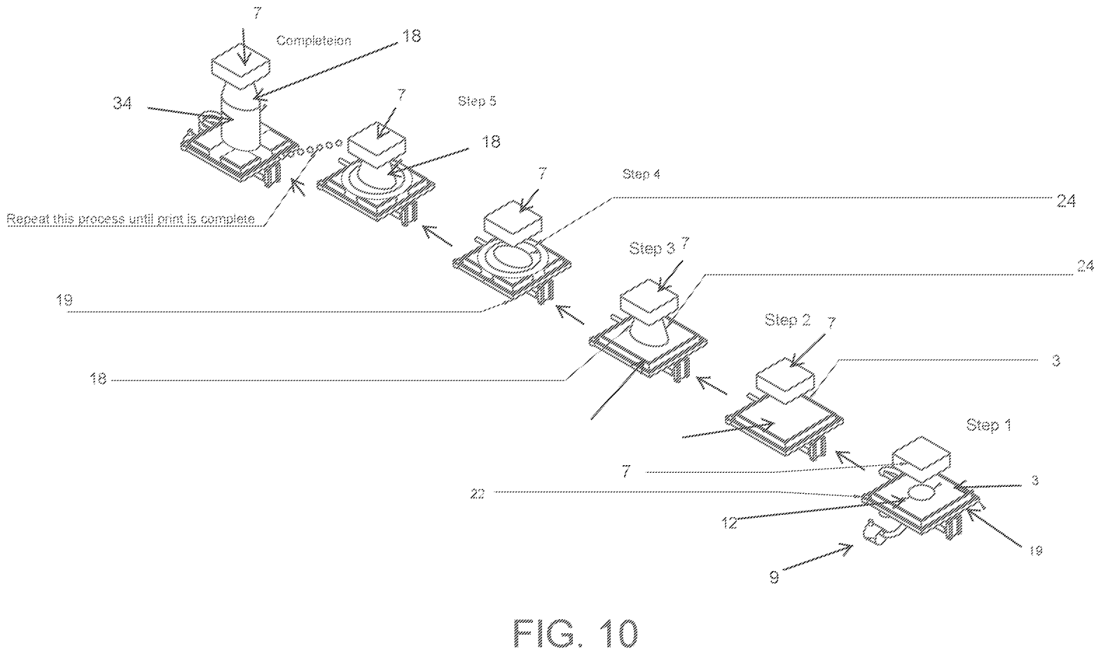

FIG. 10 depicts both schematically and with discussion certain aspects of the methods discussed in the preceding paragraphs for a bottom-up 3D, dynamic shell printing system. Note that the steps in this FIG. proceed from bottom right to top left. The exemplary methodology in this FIG. 10 includes the following:

Step 1

Fill resin to the top of build plate 3.

Step 2

Resin from a reservoir is pumped through resin pump 9 and coated over build plate 3. Build plate 3 can be recessed for the first layer if desired.

Step 3

The first layer of the dynamic shell and target object are printed via a suitable light source 7 such as a high intensity laser or image projection.

Step 4

More resin is pumped in through port 12 in build plate 3, or can be pumped through an overhead feed tube. Light projection cone 18 is beamed into light beam projection area/build arena 24. The specific shapes of light projection cone 18 and build arena 24 typically varies depending on the target object and dynamic shell shape, and further can be varied for each layer if desired. In this example the target object (toy tug boat) is 3D printed inside an oval dynamic shell. In this and some other steps, excess resin can spill into drip tray/spill-over catch tray 19 for recirculation, The build plate 3 assembly is lowered by one layer thickness (100 um is one typical thickness).

Step 5

The second layer of the dynamic shell 34 and target object are 3d printed. In some embodiments and if desired, the build arena 24 can be continuously flooded, for example when using a full image projector (e.g., a DLP rather than a laser). Steps 1-5 are repeated until print is complete.

Step 5

3D print 2nd layer. If using a full image projector (e.g., DLP rather than laser), the build area can be continuously flooded. Repeat this process until print is complete.

Completion

Once all layers of the dynamic shell and target object have been 3D printed (here, 1000 layers), they are immersed in uncured resin within the dynamic shell 34. In this embodiment the build plate 3 has been fully lowered to accommodate the height of all the layers; the entire height need not be used if so desired. The resin pump 9 is reversed to remove uncured liquid resin from the dynamic shell 34 and returned to the reservoir. Washing (e.g., automated or manual) is now possible if desired.

The target object is then removed from the dynamic shell, for example by cracking the shell open, and the target object is exposed. Guywires and other support/auxiliary structures can be easily peeled off. If desired the target object can be cured or otherwise post-processed.

FIG. 11 also depicts both schematically and with discussion certain aspects of the methods discussed in the preceding paragraphs for a bottom-up 3D, dynamic shell printing system.
Step 1: Initial flooding of build plate 3 for first layer
Step 2: Build plate 3 fully flooded to top of inlet port 12 in preparation for first layer of target object and dynamic shell (in some embodiments, a wiper can be used for high viscosity resins).
Step 3: Projecting first layer of dynamic shell
Step 4: Flooding next layer, Build plate 3 lowered by layer thickness
Step 5: Projecting next layer, move Build plate 3 down one layer, repeat step 4.
Step 6: All layers printed, Build plate 3 fully lowered
   2 target object fully printed
   3 Build plate (in this example it is recessed for low viscosity resin)
   5 Guywires; secure target object to dynamic shell
   7 Light source (turned off in step 1)
   9 Metering pump, connect to supply reservoir (supply reservoir not shown)
   11 extendable resin tube
   12 inlet port in build plate
   12b Drip catch tray
   12c Return port on drip catch tray
   13 Support mount for Vertical Z-Axis
   18 Light projection cone of desired pattern onto first layer of resin
   19 Drip Catch Tray with return port.
   19 Resin being pumped onto Build plate 3
   28 Resin spilling over as build plate 3 is flooded
   34 dynamic shell (3D dynamically created tank filled with resin)
   40 Layer of resin being pumped onto build plate 3 (each layer serves as previous layer of dynamic shell in succeeding steps/iterations)
   41 Resin (on build plate 3, e.g., for first layer in first step)
   43 Light projection cone of final layer

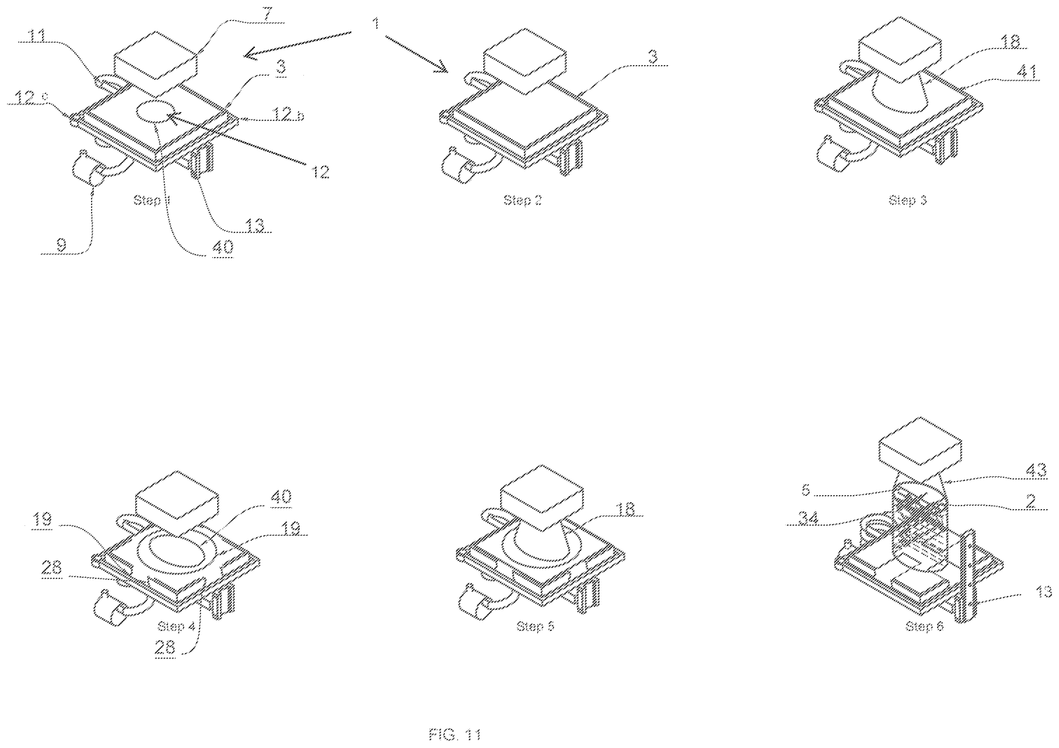

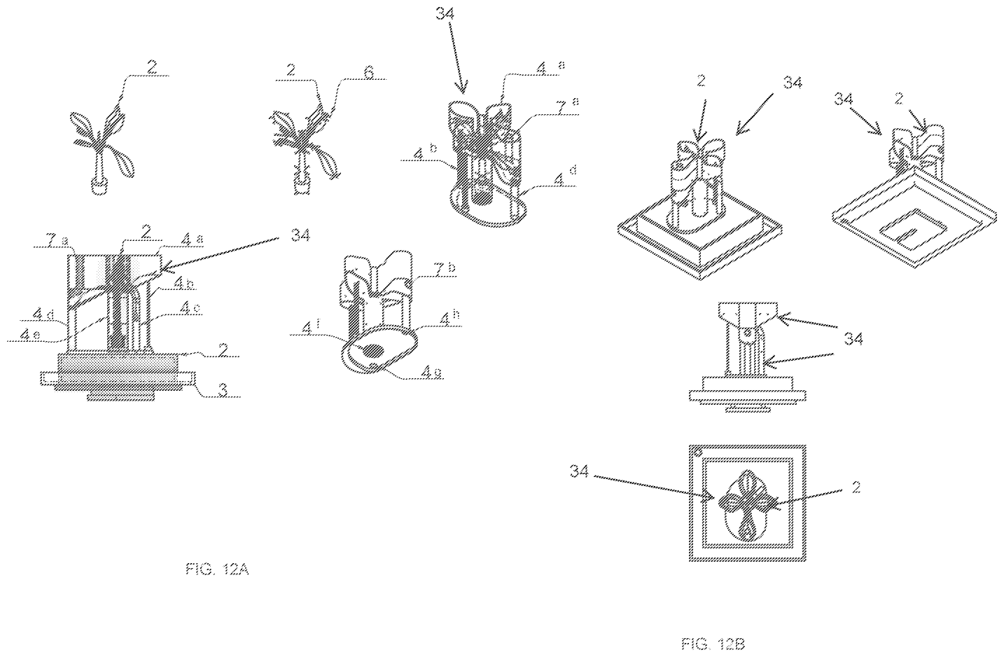

FIG. 12A depicts an exemplary embodiment of dynamic shell 34 and target object 2, wherein the dynamic shell 34 contained dynamically created plumbing in conjunction with the dynamic shell printing systems herein. FIG. 12B depicts further views of the dynamic shell 34 and target object 2 of FIG. 12A wherein the dynamic shell 34 and target object 2 have complex, complementary shapes. The dynamic shell 34 is form-fit to the target object 1 and has plumbing and external supports.

### In FIGS. 12A and 12B:

2 target object, Banana tree
4a Tight form fitting dynamic shell
4b dynamically created external vertical supports to hold up heavy sections and reduce chances of the dynamic shell breaking away from build plate.
4d dynamically built filling pipe—this provides a pathway for resin to reach overhanging areas
4e Filling pipe—pathway for resin to reach overhanging areas
4f diffuser on main up pipe to ensure all resin “plumbing” has even pressure to create even flow
4g One of two auxiliary up pipes, this provides an first inlet from the pressure plenum.
4h two of two auxiliary up pipes, this provides a second inlet the pressure plenum.
6 secondary target object, attached hanging flower pod.
7a Drain pipe to reduce resin weight and fill time
7b Drain pipe outlet
34 dynamic shell

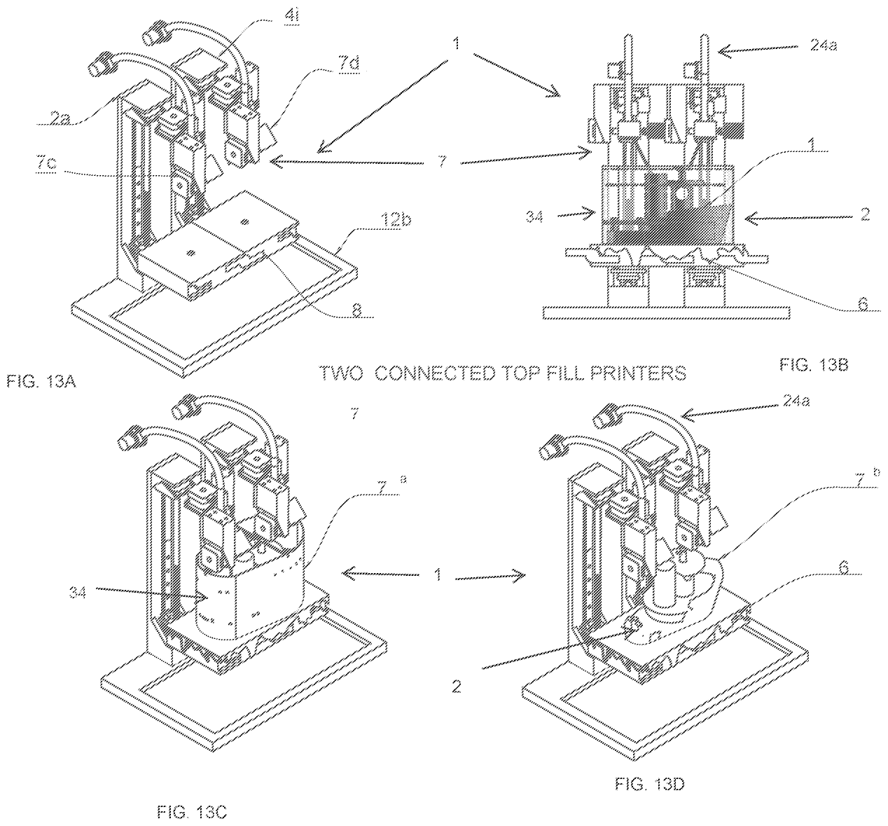

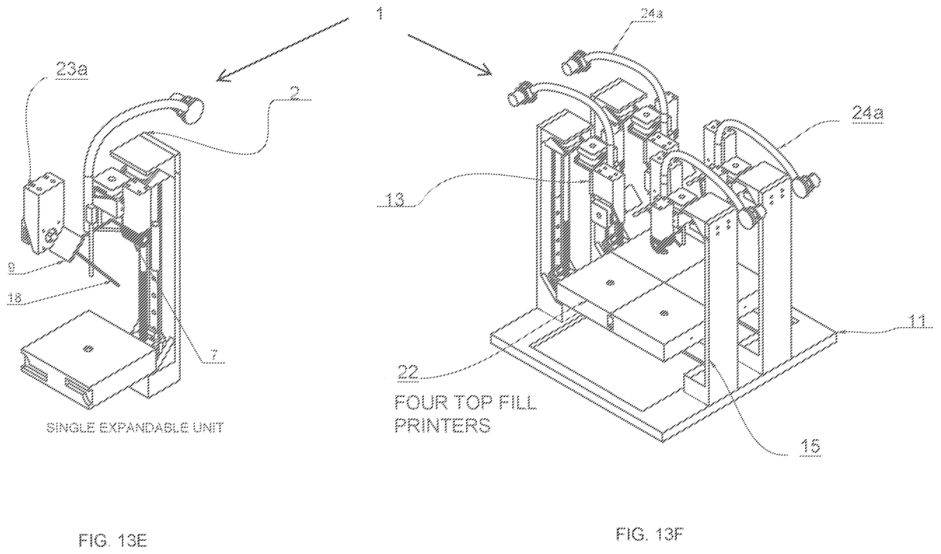

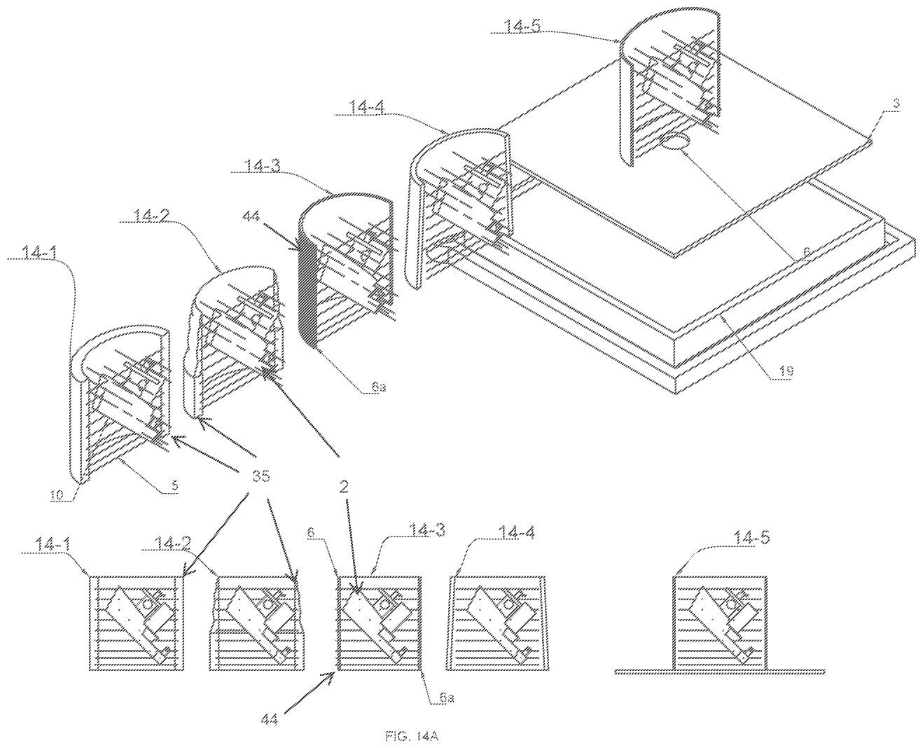

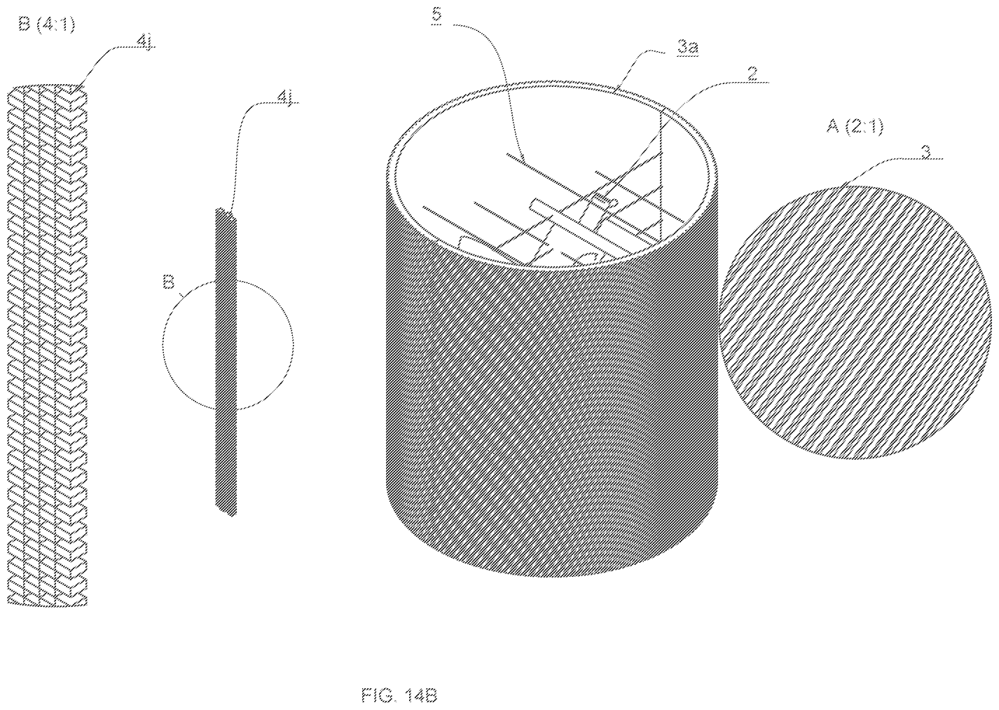

FIGS. 13A to 13F depict multi-printer dynamic shell printer systems 1 that are exemplary embodiments of the dynamic shell printing systems 1 herein. FIGS. 13A to 13D depict systems having two top-fill printers operably connected together. FIG. 13E depicts a single top-fill expandable printer, i.e., a single one of the printers shown in FIGS. 13A-13D and FIG. 13F, and FIG. 13F depicts and embodiment where four top-fill printers operably connected together. In this embodiment in FIG. 13F, a double row (2×2) is depicted; other configuration such as a single row of 4 printers (or 1+3, or a row of 5) or are possible. Other combinations of printers are also possible, for example complex shapes can be made because printers can be in series or in matrices, etc., as desired, on 1, 2, 3 or 4 sides of the printer systems 1. Complex networking and synchronization firmware and software can be used as desired. Vertical distance sensors or floats may be used to monitor and match resin levels. Wait times between printing a given level/slice may also be selected so that resin levels match each, for example due to effects of gravity, variations in target object shape, resin-injection speeds, etc.
1 tankless 3D printer system
2 target object, guywires and dynamic shell
2a First 3D printer in a system having multiple operably connected 3D printers
4i Second 3D printer in a system having multiple operably connected 3D printers
7 Light source (e.g., laser)
7a Example of a dynamic shell and target object (inside the dynamic shell) spanning two build plates.
7b target object (large toy tugboat) orientation shown (dynamic shell and guywires omitted for reference purposes)
7c Laser control by galvo first printer (typically 2 are present per 3D printer)
7d Laser control by galvo second printer
8 Interconnecting system to lock build plates together
9a Galvo mirror
11 resin overflow drip tray.
12b Resin catch tray for two operably connected printers
15 4×3D printers each having its own Z-axis control, light source and cone, resin filling system
18 Laser beam
22 Four interconnected build plates
23a Galvo motor
24a Overhead filler system with overhead feed system and hose (otherwise fills from below)
28 Resin spilling over into catch tray
34 dynamic shell

The following figures provide further depictions of and comments on the embodiments, aspects, etc., above, as well as provide additional embodiments, aspects, etc.

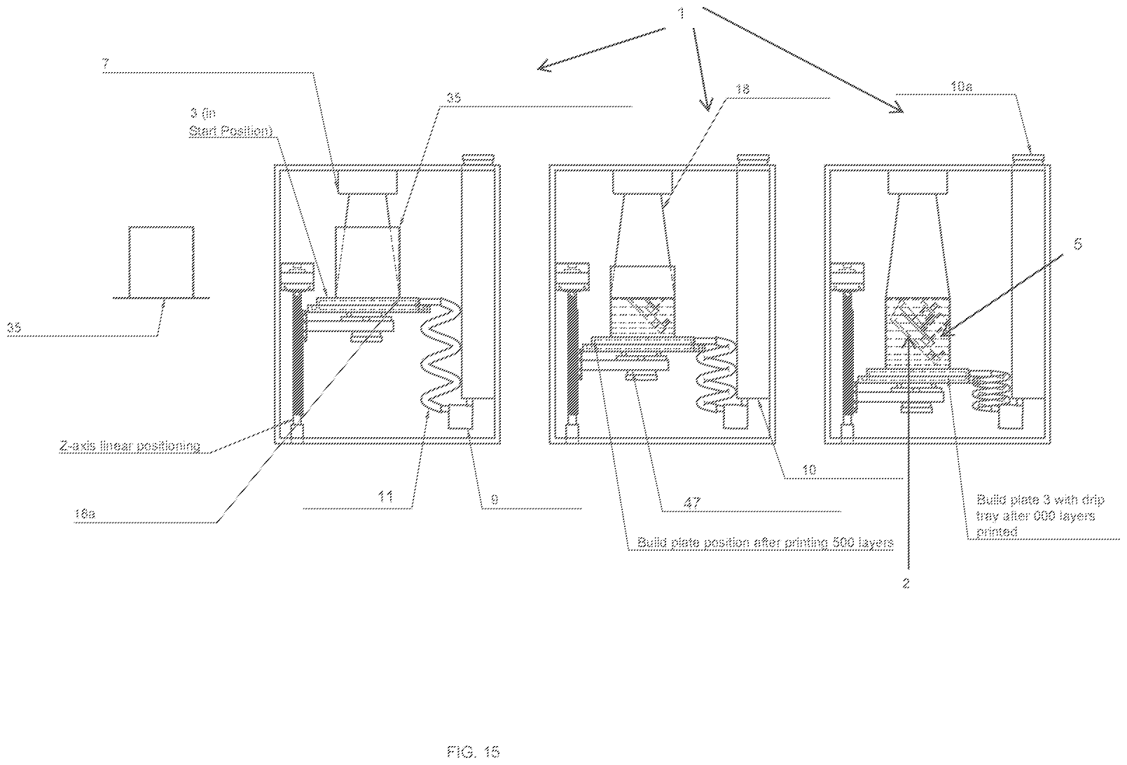

FIGS. 14A and 14B depict exemplary embodiments of degraded dynamic shell walls due to inadequate resin or other conditions. The walls of the dynamic shell may degrade from one level/slice to the next due to a variety of factors. For example, degradation can be a function of the amount of time between creation of layers, the resin viscosity, surface temperature, use of wiper or constant flood methods to file the dynamic shell, etc. Generally, for example, the lower the viscosity of the resin the more the wall thickness may degrade. The FIG. below depict exemplary methods and systems to address such degradation. The numbers 14-1 to 14-5 indicate stepped images within FIG. 14A, both perspective views (above) and side plan views (below).
14-1 Prefabricated shell 35, in this embodiment having a solid and even wall thickness. In one embodiment, the prefabricated shell 35 can be produced by Combining a conventional 3D FDM plastic hard resin filament extruder on a gantry to print the prefabricated shell 35 from different material compare to the target object, before filling the next layer, which can used to form a vertical side walled prefabricated shell 35.
14-2 Example of a dynamic shell having degraded walls
14-3 Example of a dynamic shell having a knurled outside surface 44. The texture, in this embodiment knurling, on the outside of the dynamic shell can reduce the rate of degradation between one level and the next that may occur depending on various characteristics of the resin and other conditions. Knurl patterns can include, for example, diagonal, diamond, squares, whiskers, screw threads and triangles, and the patterns can have (within a given pattern or between patterns) variable depth and spacing.
14-4 Pyramidal levels/slices. This image depicts simple solutions to degradation, namely to start with a wider base. In one embodiment, the outer surface only is pyramidal and the inside substantially straight/vertical. In another embodiment, the interior surface is also incrementally adjusted inwardly, if desired at the same level-by-level amount as the outer surface of the dynamic shell, which provides for a dynamic shell having a substantially continuous thickness from top to bottom.
2 target object
3 build plate
3a dynamic shell with simple angled knurling texture used with high viscosity resin
4j Example of deep texture made of staggered squares, for example for low viscosity resins
5 Guywires
6 Inlet port
6a Texturing (knurled outside surface 44) based on a geometry created by dynamic shell generator software.
19 spill-over catch tray
35 Prefabricated dynamic shells 35 in this embodiment do not have wall degradation. The dynamic shells 34 can be premade from resin, plastic 3D printed, cast material or sheet metal.
Insert A Scaled-up image of rectangular knurls 45/textures.
Insert B Scaled-up image of diagonal knurls 46/textures.

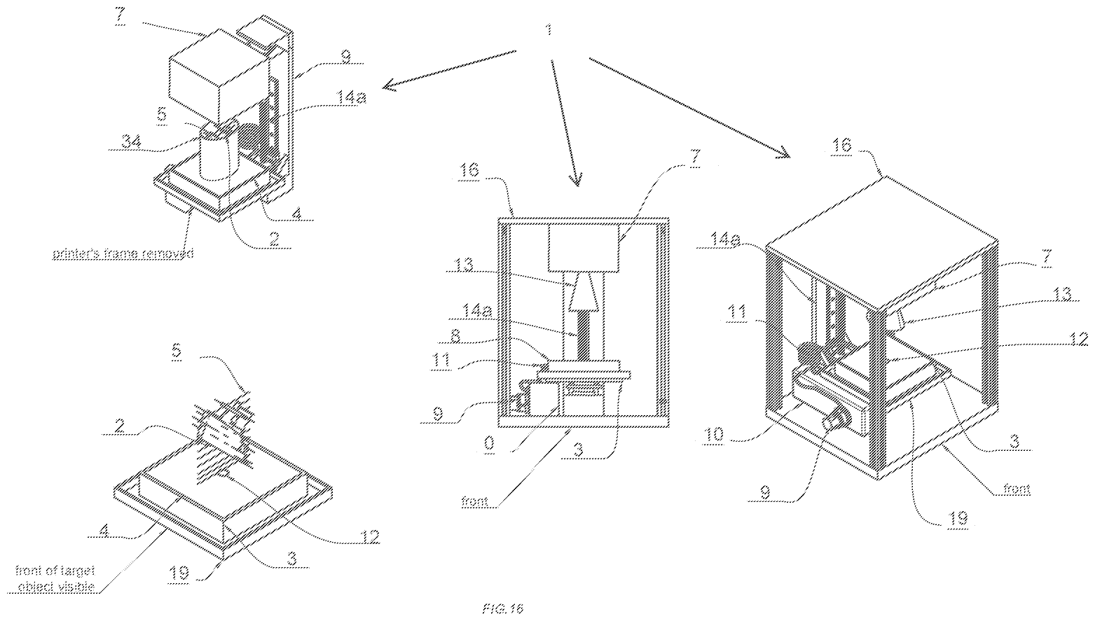

FIG. 15 depicts an exemplary embodiment of a 3D printer system 1, here a dynamic shell 3D SLA/DLP printer, suitable for use with prefabricated build tanks/shells 35. The prefabricated shell 35 may be 3D printed in resin first (before the target object 2 is built) using this embodiment, or for example printed in plastic on a conventional filament printer, 3D printed in metal or hand fabricated out of sheet metal or other materials. This approach is one way to make standardized prefabricated dynamic shells for use when printing the target object 2 and guywires 5 supports, etc. In some embodiments, the prefabricated shell 35 can be made in advance by any suitable method including methods not requiring a 3D printer. Such prefabricated shell 35 can then be provided for use within the dynamic shell 3D printer systems 1 herein. Prefabricated shell 35 are typically made from a print-resin compatible material such that dynamically printed guywires and other auxiliary structures can be printed along with the target object 2 within the prefabricated shell 35. The target object 2 can be removed, for example, by a ram (not shown) that pushes it out of the prefabricated shell 35, by the prefabricated shell having a hinge or other opening structure that permits the prefabricated shell to be opened to expose the target object 2, or otherwise as desired. The various components can be reused if desired.

Build tank in this case can be prefabricated or printed along with the objective, and disposed of or reused as desired.

FIG. 16 depicts multiple views of an exemplary embodiment of a tankless 3D printer system 1, here a dynamic shell 3D printer, as discussed herein.
1 tankless 3D printer system
2 Target object (toy tug boat) inside dynamic shell
3 Build Plate
4 First layer of resin. This layer forms a seal with the base/build plate 8. The size of the layer is optional as desired. As it is delivered, the resin coats build plate. In some embodiments, the resin can be is held in a shallow recess such as 100 um deep, depending on resin characteristics or other conditions.
5 Guywires—thin support structures, in this embodiment oriented horizontally
7 Light source (e.g., laser/galvo, DLP projector, LCD screen)
9 Resin metering pump
10 Resin supply reservoir
11 Coiled hose between supply reservoir and resin output port 1 in build plate 8. This hose can be configured to traverse the build plate 8.
12 Resin input port
13 Light projection cone
14a Z-axis vertical control, bracket and lead screw
16 Frame of printer (not show in the two left-most views of FIG. 16)
34 dynamic shell
19 Resin catch tray/gutter. Spillover resin is caught and can be returned to supply reservoir for reuse

FIG. 17 depicts multiple views of an exemplary embodiment of a dynamic shell 3D printer 1 as discussed herein using multiple build materials (here, different resins) and/or different 3D printing mechanisms such as FDM with DLP. In this Figure:
4k 3d printer computer control system
8a Gantry X-axis stepper motor
10b Gantry y-axis stepper motor
   14b Z-axis guide rails
   14c Z-axis drive screw
   14d Z-axis positioning stepper motor (can also be a servo motor or other desired motive force)
45a Laser beam
45b X-Mirror positioning motor
45c Y-Mirror positioning motor
45e Y-Mirror
47a Main resin supply reservoir, which is used to make the target object and dynamic shell in this example
47b Extendable resin hose (+/−Z-axis)
47c Resin metering pump, can meter resin flow from the main supply reservoir
51 Resin metering pump, secondary supply reservoir
52 Injection resin supply flexible hose
53a Dynamic shell (only the right ½ shown)
53b guywires
53c Target object, toy tug boat
55 Resin injection needle, mounted on gantry positioning system, in this image the needle is making a guywire out of a different resin than primary resin. This also demonstrates one embodiment of using different resins or other build materials in a single build

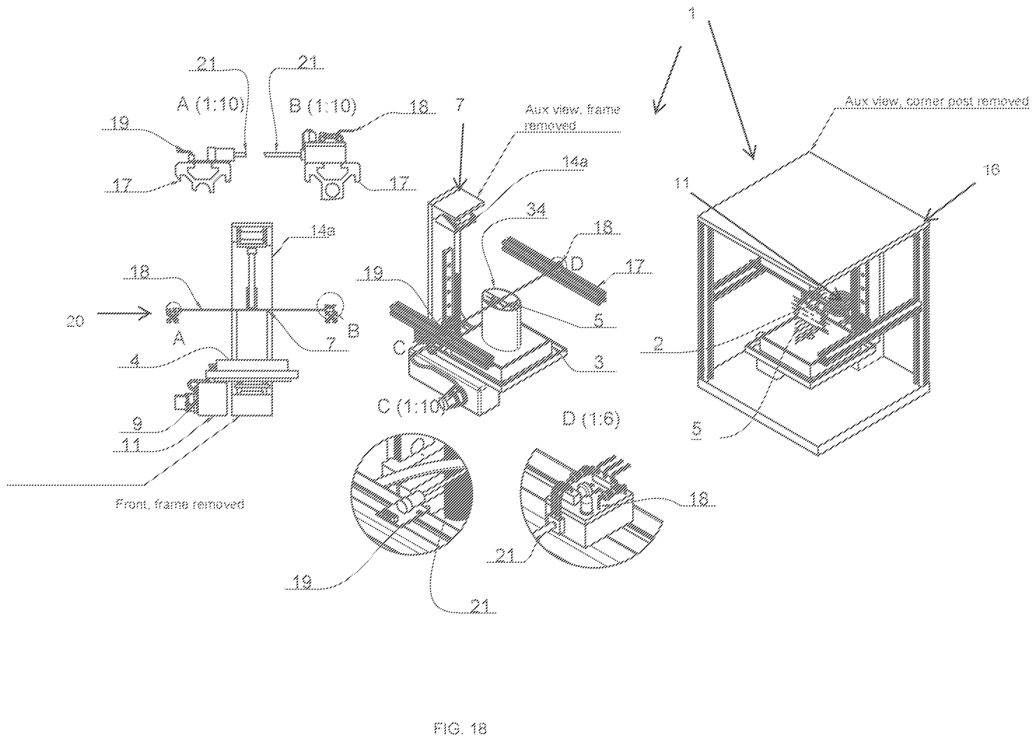

FIG. 18 depicts multiple views of an exemplary embodiment of a dynamic shell 3D printer as discussed herein having a laser level 20. Such a laser-based level system can be used, for example, as a height detector, for example to measure correct height of a printing layer and for error detection.
1 tankless 3D printer system
2 Target object (toy tugboat) inside dynamic shell
3 Build plate
4 First layer of resin applied to build plate 3. This layer forms a seal to the base/build plate 3. The size, thickness, shape, etc., of the layer of resin can be set as desired. Here, the resin coats build plate 3 (or prior layer of resin in later slices of the target object), or could be retained in a shallow recess such as 100 um depending on resin characteristics and other conditions.
5 Guywires
7 Light Source (e.g., Laser/Galvo, DLP projector, LCD Screen).
9 Resin metering pump
11 Coiled hose between supply reservoir and resin port 12 in build plate 3. This hose can be configured to traverse the build plate 3.
14a Z-axis vertical control, bracket and lead screw
16 Frame of printer
20 laser level
18 Laser “break beam” detector (photovoltaic)
19 Laser emitter
21 Laser beam
34 Dynamic shell

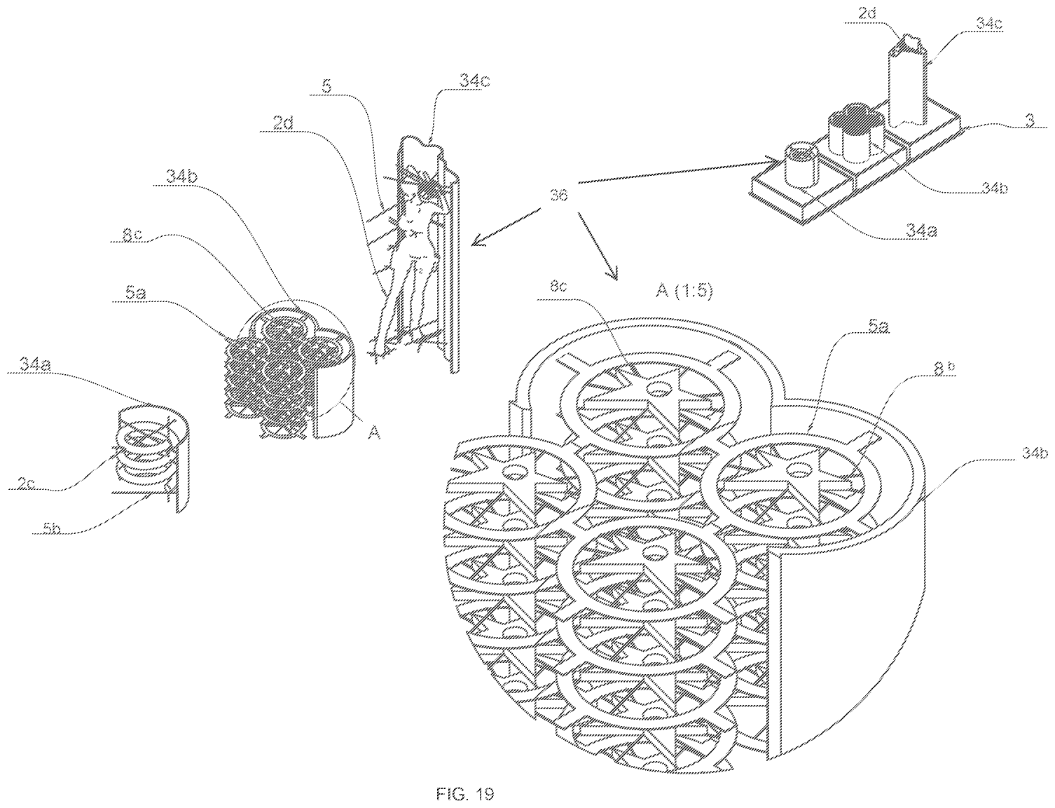

FIG. 19 depicts multiple views of exemplary embodiments of complex 3D printed dynamic shells 36 and complex target objects 2e as discussed herein. Such complex 3D printed dynamic shells 36 can be nested, have shapes within shapes, have curves or coils, etc.
2c Target object comprising a complex coil
2d Target object, a female gun fighter figurine
5 Guywires, in this embodiment spaced 5 mm to hold dynamic shell shape, along with guywires at each overhang and undercut as desired. Guywires can be automatically generated using software.
5a Thin guywires 3D dynamically printed at same time as the layers of the coil and the dynamic shell
5b Stacked guywires, both thin and wide to provide a guywire frame for example to hold delicate target objects.
8 Stacked thin target objects (stars)
8b Small guywires
8c Star shaped target object
34a Round dynamic shell
34b Cloverleaf dynamic shell
34c Form-filling dynamic shell “shower drape style” vertical side walls

FIG. 20 depicts multiple views of exemplary cantilevered supports for 3D printed dynamic shells and target objects herein. In some embodiments, such dynamic shells 36 and complex target objects 2e can include cantilevered supports.
2f Spherical target object
48 heavy support having 4 helices
5b guywire upper
5c guywire lower
34 dynamic shell
48 heavy support having 4 helices
49 heavy support having 2 helices
50 base support. This structure can be, for example, a flat plane, baffle, or other desired shape used as a base for angled heavy supports, cantilevers or other structures that, for example, can “hang off” these base supports. The base supports can be disposal able and can span the distance between side walls of approximately opposing positions

The following FIG. focus on the build plate and related aspects, and continue to provide further depictions of and comments on the embodiments, aspects, etc., above, as well as provide additional embodiments, aspects, etc. (including embodiments beyond build plates).

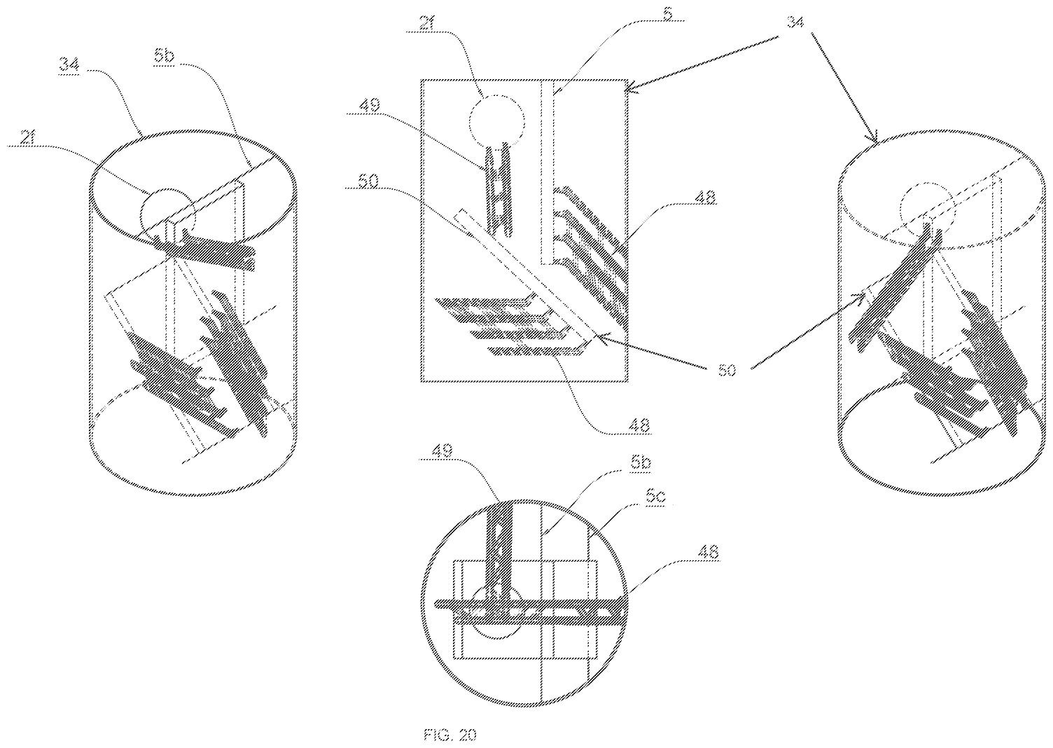

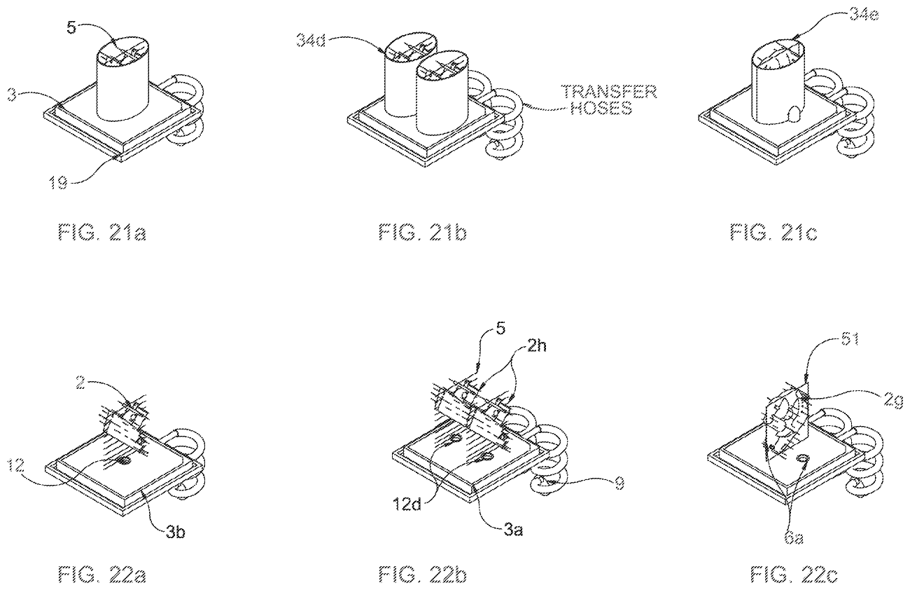

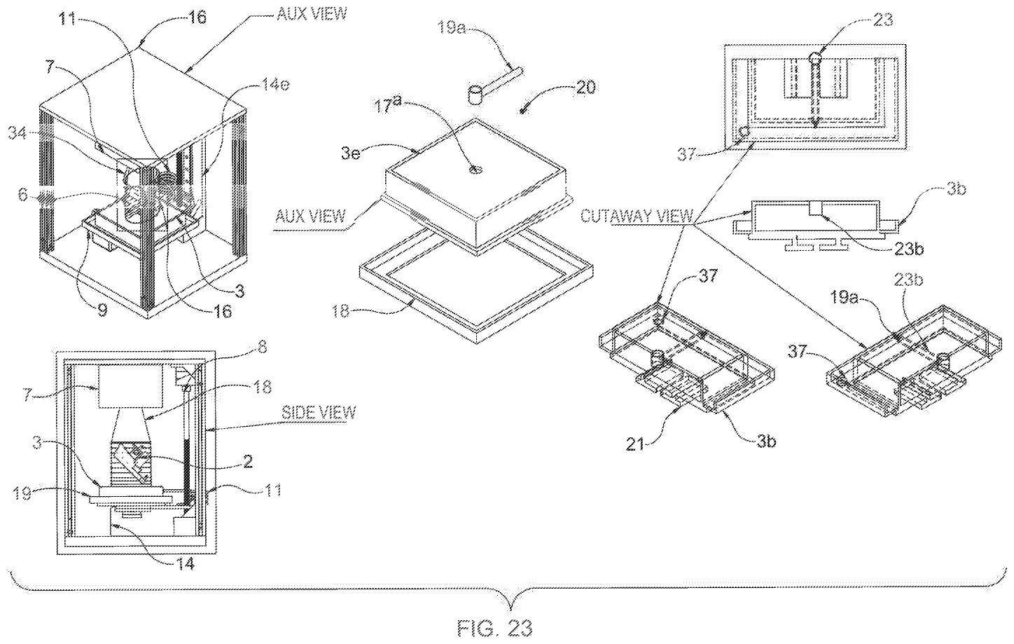

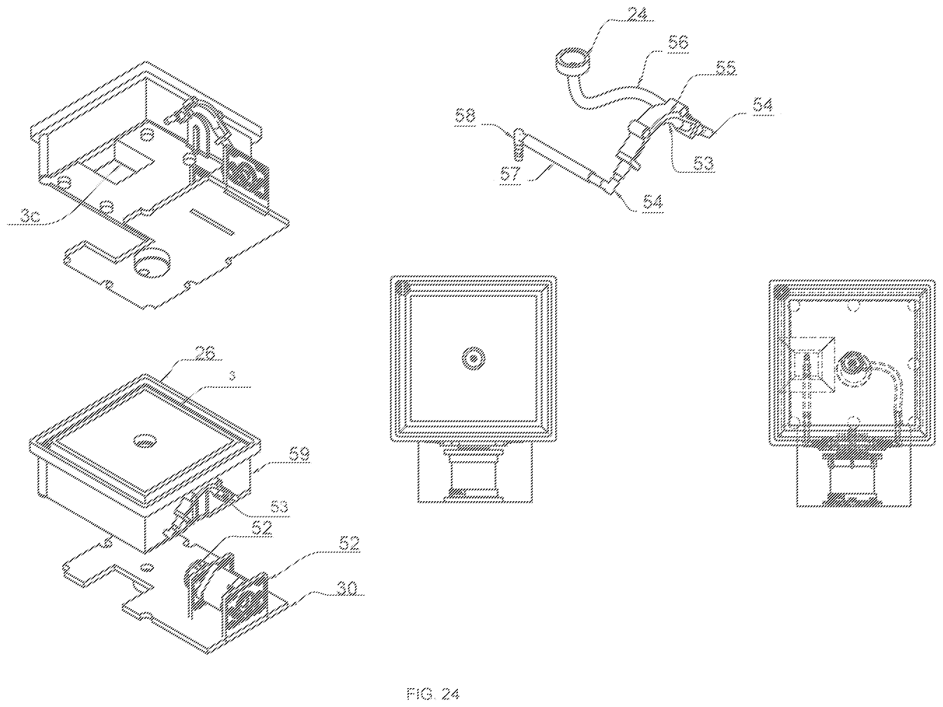

FIGS. 21A-21C and FIGS. 22A-22C each depicts multiple views of exemplary embodiments of dynamic shell 3D printers as well as 3D printed dynamic shells and target objects as discussed herein.
2 Single target object
2g One target object, two materials
2h Two target objects. If desired, each can be made from resin from a different port, and if desired different resins can be used on each target object
3 Build plate top, recessed to support a first layer seal or a prefabricated dynamic shell with a plate seated into the recess and indexed for correct orientation. See notched corner (add reference)
3a Build plate with single inlet port
3b Build plate with dual inlet ports.
4 Single dynamic shell with two ports. Also shown is extended plumbing at base/build plate
5 Guywires fused to dynamic shell wall. Typically detached during post-processing.
6a Dual resin inlet ports
9 Bidirectional metering pump. This inputs resin and if desired can remove resin as well. Typically use one pump per port. Multiple ports could be used to fill faster.
12 single outlet port, can be with or without diffusers
12d Dual outlet ports, both with and without diffusers
19 Drip tray with return port (port not shown)
21a Single dynamic shell (dynamic shell) with on build plate
21b Detail of single port build plate with target object, dynamic shell not shown
21c Dual dynamic shells building two target objects, both in a single dynamic shell. The dynamic shell can be prefabricated or dynamically created.
22a Detail of dual port build plate with two target objects. Different parts of each target object can be made of a different build materials. If desired two pumps can be used.
22b Dual ports used to create one object made of two different materials.
22c Dual port build plate with target object printed with a partition to separate different materials used in the same object. Can be two different colors if desired, two materials having different properties (if desired, to create a build/mold system approximating injection molding in terms of product output). As an example, the materials can provide a rubber layer over a hard plastic layer. 34d Dual dynamic shells. As with certain other embodiments, this can be made,
for example, using a DLP or other desired light/energy source. If a laser is used, the angle can be occluded if the set-up is not carefully laid out.
34e Single dynamic shell made using two ports. As with certain other embodiments, this dynamic shell can be removable and reusable.
51 dynamically printed partition. If desired, one target object can be made with two different materials.

FIG. 23 depicts an exemplary embodiment of various elements for a build plate 3 having a resin return system to reuse resin within the dynamic shell 3D printer as discussed herein.
2 target object (held by guywire supports, typically immersed in resin during the build)
3 build plate
3a Build plate (enlarged). This embodiment uses a recess to accept a prefabricated tank (dynamic shell?) or to create a tight sealing first layer of the dynamic shell
3b Build plate assembly (build plate and drip tray)
7 light source
11 Extendable resin delivery hose
14e Z-axis control system
16 Device support frame
17a resin inlet (inlet into the build arena, outlet of the supply system (can be more than one if desired)
18 Resin drip tray with return port
19 Drip tray with return port
19a Resin transfer tube
20 hose attachment fitting, connects to resin transfer tube to the resin inlet tube; this fitting can provide an external interconnect between the feed hose and the inlet tube that's internal to the build plate.
21 Build plate z-axis mounting bracket.
23b Resin delivery assembly (outlet port liner, transfer tube, and hose fitting)
34 dynamic shell
37 Resin return port, returns unused resin to supply reservoir

FIG. 24 depicts an exemplary embodiment of a dynamic shell 3D printer as discussed herein having a combined build plate and supply reservoir.
2c Alignment pins
2d Return drain tube
2f Resin outlet port
3 Build plate
3c Sump
24 Outlet port diffuser
26 Plug, refill inlet
30 Z-axis mounting port
52 Dosing pump & impeller
53 Resin Distribution assembly
54 Elbow connectors (2)
55 Tube guide
56 Outlet tube
57 Pick-up tube
58 Pick-up port
59 Supply reservoir

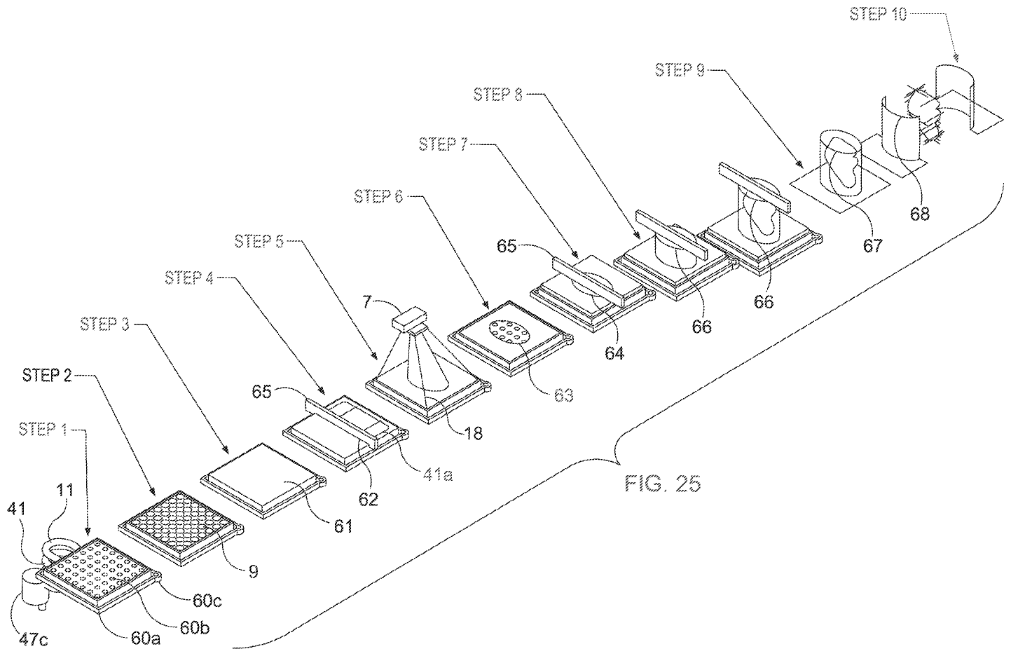

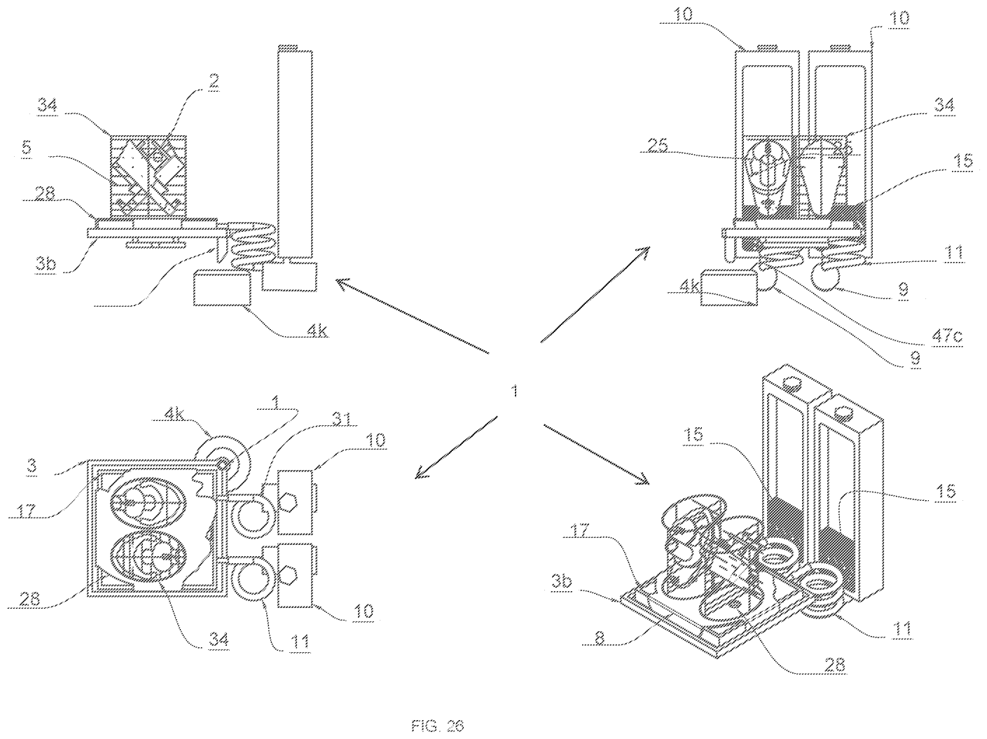

FIG. 25 depicts an exemplary embodiment of certain methods of using a dynamic shell 3D printer as discussed herein having a multi-port build plate, for example for high rate of flow of resin
Step 1 cleaned build plate
Step 2 resin pumping on the build plate. For the initial layers of target object, and otherwise as desired, resin can be slightly overflowing
Step 3 build plate overflowing into drip tray
Step 4 excess resin wiped away form first layer of resin
Step 5 first layer pattern being cured by light projection
Step 6 unused ports are sealed by cured resin
Step 7 uncovered ports fill with resin, excess is wiped away, next layer is exposed
Step 8 process repeats until target object is completely printed
Step 9 object completed
Step 10 shell separated to show target object
7 Light projector or other energy source (e.g., image or laser pattern)
9 Inlet pump
11 resin delivery hose, expandable
31 Light cone projection pattern
41 Resin (to be pumped up through build plate through ports to cover the build plate)
41a Resin smoothed to the desired thickness of the first layer, for example 100 um
47c Metering pump
60a spill catch tray return port
60b Outlet Ports (7×7 in this embodiment)
60c Build plate with catch tray
61 Build plate covered in resin spilling over into catch tray
62 build up of excess resin, which spills into the catch tray
63 Ports used to continue pumping resin. Can be exposed (open) or covered to stop resin flow.
64 First layers of target object, resin pumping into exposed area and slightly overflowing
65 Wiper device to sweep away excess resin for higher viscosity resins
66 Partially printed target object
67 Completed printing target object
68 target object removed from dynamic shell

FIG. 26 depicts multiple views of exemplary embodiments of a dynamic shell printing system 1 as discussed herein comprising multiple reservoirs and multiple target objects and dynamic shells. Such multi-reservoir systems can provide resins having different characteristics for different parts/portions of the target or dynamic shell, for example different colors, flow characteristics, different set characteristics, different densities, etc. Such multi-reservoir systems can, if desired, be used with multi-port systems such as those in FIG. 21. The numerals in the figure are consistent with those in other Figures herein.

Some further comments on the embodiments, aspects, etc., above, as well as additional embodiments, aspects, etc., follow:

A port in the bottom of the build plate provides the resin needed make the walls of the dynamic shell and subsequently fill it such that the target object is formed while immersed inside the newly formed tank.

If desired, for example to achieve even flow of resin through the port and/or through or around the target object, a series of diffusers and plumbing such as “stand pipes” can be dynamically created during the 3D printing process.

The light source can be any suitable source of adequate power and wavelength, for example a UV laser of high intensity such as 150 mw to 300 mw or more. The light or other transformational energy forms the first layer of the wall of the of dynamic shell and if desired piping or other auxiliary structures, as well as the target object(s). Typically, the strength and features of the structures, including the dynamic shell and auxiliary structures, can be selected to assure both that the structures provide desired support, fluid transmission, adhesion to the build plate, etc. The fluid level of within and for the dynamic shell is increased as desired (e.g., 10 um to 100 um) to form the next layer of the dynamic shell, diffusers, fill pipes and target object itself.

This process continues until the fill pipe is fully enclosed and the walls of the dynamic shell are high enough to maintain a seal to the fill pipe.

While building the walls of the dynamic shell, structures such as guywires can be formed as desired to support the target object during the build. Such guywires/support structures can extend from the target object to the sides of the dynamic shell, or to the build plate, or to other structures being built/printed, including for example between different target objects being built simultaneously. These support guywires can be horizontal, vertical, or oblique, and can be quite thin (e.g., 20 um, 200 um thicknesses), and such auxiliary structures can be selected to be naturally pretensioned by selecting a resin that shrinks slightly when cured by the light pattern. The guywires can, for example, hold layers of the target object in place during the fill sequence. Where the guywires can be selected to be very thin so they can be easily removed, thereby leaving little or no artifacts and smooth surfaces.

In certain embodiments, at each layer the fluid level increases just enough to form the wall of the dynamic shell, the resin fluid is pumped through the inlet port by a dosing pump (for example a peristaltic pump).

In many embodiments, the printing processes, systems, etc., can be configured such that as the resin gushes upward it can spill over the side of the dynamic shell. The spill-over resin can drip back onto the build plate or into a collection area or collection flask, etc. Where the resin spills onto the build plate or similar structure, a surround catch tray collects such excess resin and directs it back to the resin supply reservoir.

Any light scatter, if any, that causes semi-hardening of the resin between the target object and the wall of the dynamic shell can be addressed by configuring a gap between the wall and the target object to be of sufficient size to ensure the target object will not be affected by such light scattering.

Supports such as guywires and auxiliary structures herein can be thinner and less complex than for tank-based 3D printers because such the resin can be selected such that the density of the hardened resin is equal to the liquid resin and therefore equally buoyant.

The fluid level within the dynamic shell can be topped off and controlled by virtue of the wall height and the relative placement of the build plate.

Once the 3D print is completed (the target object is finished) the dynamic shell can be drained of fluid by reversing the inlet port flow direction. If needed or desired, the recovered resin can be passed through a filter to remove hardened or partially cured resin globs. The clean resin is returned to the storage tank/bottle for reuse or swapping with a different resin.

Any surface that contacts the resin, such as the dynamic shell and its contents, plus the build plate, and inlet and outlet tubes can be flushed automatically with cleaning solution, recirculating as need to wash away any liquid resin away. The used cleaning solution can be recycled, and can be optically monitored to determine if it needs to be replaced or the tank holding the cleaning fluid need replenishing.

The target object and its dynamic shell can be removed from the build plate by any suitable method, for example by lightly prying it off the build plate. In some embodiments, the build plate can be covered in a low adhesion coating such as Teflon.

The target object can be separated from the dynamic shell by any suitable method, for example by splitting it open along perforations built into the source geometry and dynamic shell. Such perforations typically do not fully pierce the dynamic shell prior to completion of the print/build.

The target object can be hardened post-printing by curing in sunlight or in a UV light chamber or otherwise as desired, and the dynamic shell can be retained or discarded as desired.

Scalability of the systems, methods, devices, etc., herein can be achieved using multiple 3D printers with mechanically coupled build plates in conjunction with coupled dynamic shells. This permits the formation of target objects larger than the build area of a single printer. Coordination software can automatically keep the dynamic shells, build plates and target object sections perfectly aligned to avoid leaks due to platform malalignment. Thus, large target objects and complex target object shapes (along with their dynamic shells) can be built within, and thus span, multiple operably connected 3D printers. Where the connection includes fluid connection, the multiple printers can simultaneously print each layer within the respective printer's print zone at the same time. The dynamic shell 3D printers can even share fluids/resins—or use different build material types. Cross-system plumbing can be configured and arranged to gang multiple pumps together. This can be of particular benefit to large commercial operations.

The layer thickness can be controlled via any desired method, for example via a mechanical sweeper that spreads out the resin evenly at the surface, or via an optical monitoring system that controls the flow rate and stepping of the build plate. These can be called wiper and wiperless methods.

In some embodiments, the wiper method fills one layer at time, the first stage pattern for each layer is to build a wall geometry pattern (i.e., build the dynamic shell first). If this is overfilled, the resin spills over and runs into a catch tray and recycled. The resin level is reduced for example via pump reversal, then a sweeper device, i.e., the wiper, such as a metal bar, takes off any excess resin height thus setting the layer thickness. A minor amount of excess resin remains after such sweeping, and can bring up the level inside the walls of the dynamic shell then the target object is layer pattern is projected from the light source (or other curing source) and hardened. The build plate is then lowered/raised as may be the case to increase the distance between the build plate and the light source by one layer and the process repeats. If the resin level in the newly formed dynamic shell at a given layer is less than desired, then a second filling and wipe operation can be performed for each layer needing it. The overall printing/build time of the current dynamic shell 3D printing systems, methods, etc., is faster than prior shallow tray or deep tank systems because the sweeper can move very quickly because it only has to wipe the size of the dynamic shell, so the pump can run at virtually any speed.

In some embodiments, the wiperless system constantly pumps fluid into the build plate, and then the light projection system, or other curing-energy system, casts patterns in a staggered sequence at a rate that is synched with the fill rate to build the dynamic shell and target object. The pattern can be projected multiple times per layer if desired to achieve the desired final pattern at completion of the desired layer thickness. A DLP system is one effective approach in this design because it can project across the entire surface at one time. A SLA-Laser is another effective approach and can be used alone or in conjunction with a DLP to form the walls of the dynamic shell and/or the target object.

The design, shape and other features of the dynamic shell can be selectively configured to form-fit to the shape of the target object being printed. Classic vertical support structures, or other support structures that do not make contact with the target object can be used to support the dynamic shell if desired. A tightly formed dynamic shell reduces the amount of fluid in the system at any given time.

The dynamic shell may be automatically designed by analyzing the target object geometry and then calculating a suitable set of “dynamic shell walls” to build to keep the target object immersed in fluid on a layer by layer basis. Such calculation can be done pre-build or dynamically or otherwise as desired.

Dynamic shell walls can have “running grooves” wherein layers are latently formed, thereby providing an aqueduct below the current layer level to help distribute fluid. In other words, the dynamic shell can be formed with grooves that help distribute the resin or other build medium to desired target areas within the dynamic shell/within the build zone.

Dynamically created plumbing such as standpipes, drains, diffusers, defusers and sealable valves can be formed as desired to accommodate for fluid dynamics and other factors, for example to reduce the chance of damage to the formation of thin layers of target object and guywires due the pumping action of the resin moving through an entirely open system.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

Unless otherwise stated, adjectives herein such as “substantially” and “about” that modify a condition or relationship characteristic of a feature or features of an embodiment, indicate that the condition or characteristic is defined to within tolerances that are acceptable for operation of the embodiment for an application for which it is intended.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

What is claimed is:

1. A three-dimensional (3D) printing system lacking a preexisting printing vat and containing a dynamic shell printed by the 3D printer and having an interior space within the dynamic shell, such interior space holding a target object printed by the 3D printer, the 3D printing system further comprising a storage reservoir holding printing material and operably connected to the dynamic shell and target object to provide printing material to the dynamic shell and target object, an energy source that selectively cures the printing material to create the dynamic shell and target object, a build platform moveable in a z-axis to vertically move the dynamic shell and target object when the dynamic shell and target object are being built, and a computer for controlling the 3D printing system.

2. The three-dimensional (3D) printing system of claim 1 wherein the computer and 3D printing system are configured to simultaneously print the dynamic shell and the target object in a step-wise, layer-by-layer manner.

3. The three-dimensional (3D) printing system of claim 1 wherein the dynamic shell further comprises dynamically created, non-vertical guywires holding the target object to the dynamic shell.

4. The three-dimensional (3D) printing system of claim 1 wherein the dynamic shell and the target object are made of a same 3D printing material.

5. The three-dimensional (3D) printing system of claim 1 wherein the dynamic shell and the target object each contain different 3D printing materials.

6. The three-dimensional (3D) printing system of claim 1 wherein the dynamic shell further holds at least one dynamically created auxiliary structure.

7. The three-dimensional (3D) printing system of claim 6 wherein the auxiliary structure is a diffuser that diffuses liquid printing material being delivered into the interior space within the dynamic shell.

8. The three-dimensional (3D) printing system of claim 6 wherein the auxiliary structure comprises a plumbing that conducts printing material from a first location within the dynamic shell to a second location within the dynamic shell.

9. The three-dimensional (3D) printing system of claim 1 wherein the 3D printing system is in process of building the target object.

10. The three-dimensional (3D) printing system of claim 1 wherein the 3D printing system is in process of printing the target object and simultaneously printing the dynamic shell.

11. The three-dimensional (3D) printing system of claim 1 wherein the shape of the dynamic shell substantially matches the exterior shape of the target object.

12. The three-dimensional (3D) printing system of claim 1 wherein the wherein both the target object and the dynamic shell have multiple, different bi-directional curves.

13. The three-dimensional (3D) printing system of claim 1 wherein the 3D printing system comprises a plurality of operably connected 3D printers.

14. The three-dimensional (3D) printing system of claim 1 wherein the dynamic shell comprises partial perforations for easy splitting open of the dynamic shell.

15. The three-dimensional (3D) printing system of claim 1 wherein the 3D printing system comprises a build plate holding the dynamic shell and target object, and wherein the build plate is controllably movable in a z-axis relative to the dynamic shell and target object in order to print the dynamic shell and target object in a layer-by-layer manner.

16. The three-dimensional (3D) printing system of claim 1 wherein the dynamic shell contains multiple, different target objects.

17. The three-dimensional (3D) printing system of claim 1 wherein a dynamic shell wall of the dynamic shell has a substantially even wall thickness from top to bottom of the dynamic shell wall.

18. The three-dimensional (3D) printing system of claim 17 wherein the dynamic shell comprises grooves that selectively distribute printing material to desired target areas within the dynamic shell.

19. The three-dimensional (3D) printing system of claim 1 wherein the 3D printing system contains a plurality of the dynamic shells, each dynamic shell containing a separate target object.

20. The three-dimensional (3D) printing system of claim 1 wherein the 3D printing system contains a plurality of inlet ports supplying printing material to the dynamic shell, each inlet port supplying a different printing material.

21. The three-dimensional (3D) printing system of claim 1 wherein the 3D printing system contains at least one target object comprising each of the different printing materials.

22. The three-dimensional (3D) printing system of claim 1 wherein the 3D printing system contains at least a first target object made of a first printing material and a second target object made of a second printing material.

23. The three-dimensional (3D) printing system of claim 1 wherein there is a gap between a wall of the dynamic shell and the target object of sufficient size to ensure the target object is not affected by light scattering that may occur between the wall of the dynamic shell and the target object.

24. A three-dimensional (3D) printer lacking a preexisting printing vat and containing a dynamic shell printed by the 3D printer and having an interior space within the dynamic shell, such interior space holding a target object printed by the 3D printer.

25. The three-dimensional (3D) printer of claim 24 wherein the dynamic shell further comprises dynamically created, non-vertical guywires holding the target object to the dynamic shell.

26. The three-dimensional (3D) printer of claim 24 wherein the dynamic shell further holds at least one dynamically created auxiliary structure.

27. The three-dimensional (3D) printer of claim 24 wherein the 3D printer is in process of printing the target object and simultaneously printing the dynamic shell.

28. The three-dimensional (3D) printer of claim 24 wherein the shape of the dynamic shell substantially matches the exterior shape of the target object.

29. A dynamic shell printed by a 3D printer, the dynamic shell having an interior space within the dynamic shell, such interior space containing a target object printed by the 3D printer at substantially the same time as the dynamic shell.

30. The dynamic shell of claim 29 wherein the dynamic shell is located within the three-dimensional (3D) printer.
